(19) United States
(12) Patent Application Publication
(10) Pub. No.: US 2003/0093497 A1
(43) Pub. Date: May 15, 2003

(54) Digital content production system, a digital content production program, and a digital content production method

(76) Inventor: Hirotaka Ohashi, Chino-shi (JP)

Correspondence Address: EPSON RESEARCH AND DEVELOPMENT INC, INTELLECTUAL PROPERTY DEPT, 150 RIVER OAKS PARKWAY, SUITE 225, SAN JOSE, CA, 95134, US

(21) Appl. No.: 10/267,178

(22) Filed: Oct. 9, 2002

(30) Foreign Application Priority Data
Oct. 10, 2001 (JP) 2001-312946

(51) Int. Cl. G06F 7/00; G06F 17/30; G06F 15/16

(52) U.S. Cl. 709/217; 707/10

(57) ABSTRACT

When compiling digital content for output by segmenting and storing the included information to different data storage frames, the digital content production system clearly denotes the correlation between data storage frames so that the output digital content is easy to read and follow. When text data cannot fit completely within a text data storage frame, the content distribution terminal flows a flow object containing the overflowing part of the text data to another text frame, and adds the same identifying symbol to both the source frame from which the flow object overflows and to the destination frame into which the overflowing text is stored.

### BACKGROUND OF THE INVENTION

1. Field of the Invention

The present invention relates to a system, a program, and a method for producing digital content for output. More particularly, when producing digital content for output by segmenting and storing the included information in different data storage frames, the invention involves making the correlations between these data storage frames readily apparent and producing digital output content that is easy to read and follow.

2. Description of the Related Art

Digital content distribution systems for serving news and other digital content to users are already available. These digital content distribution systems generally read digital content from a content database, edit the read content to produce digital content for distribution, and thus serve the edited content to users. Part of this digital content editing process is creating a layout that makes it easy for the user to read, follow, and understand the included content. This is generally accomplished by creating a number of data storage frames in the layout area for holding the images, text, and other information included in the digital content, and then storing this included information in these data storage frames.

A problem with this layout process, however, is that the included information may not fit inside the assigned data storage frame and thus overflows from the frame. Various technologies are available for handling such data overflows, including the text editing apparatus taught in Japanese Patent Laid-Open Publication (kokai) H1-150965 (technology 1 below), the text display apparatus taught in Japanese Patent Laid-Open Publication (kokai) S60-263225 (technology 2 below), and the text production apparatus taught in Japanese Patent Laid-Open Publication (kokai) H10-187714 (technology 3 below).

Technology 1 prevents editing errors by the editor and reduces the mental burden on the layout editor when updating a document by displaying a text overflow marker when the result of a document update process for a given page will not fit on the page.

Technology 2 significantly improves the efficiency of document production and makes editing simpler for the layout editor by displaying the print layout on the display screen and indicating in the print layout when any part of the text overflows the data storage frame. The data storage frame is normally black but is displayed red to indicate that part of the document that overflows the data storage frame.

The typesetting controller of technology 3 drives an overflow data generator to calculate the amount of text overflow and display the text on a display unit if the typesetting unit detects that a text string will not fit in a data storage frame when inserting a text string input from a text input unit or text string memory to a data storage frame stored in formatting data for laying out a document.

This makes it easy for the layout editor to know how much text overflows from the data storage frame when inserting text strings to data storage frames for laying out a document.

Because technologies 1 to 3 are each directed to supporting the editing tasks of the layout editor and notifying the layout editor by some sort of display means when part of the document overflows a data storage frame, such indications are not contained in the final digital content prepared for distribution. When part of the document overflows the data storage frame and the included information is thus split and stored in different data storage frames, it is difficult for the user receiving the digital content to follow the correlation between the data storage frame from which data overflows (the “overflowing data storage frame” or “source frame” below) and the data storage frame to which the overflow data is stored (the “overflow data storage frame” or “destination frame” below), thus making it difficult to read the document.

The relationship between the overflowing data storage frame and overflow data storage frame can be made clear by adding guidance such as “continued on page XX” referencing the overflow data storage frame to the overflowing data storage frame. However, if there is more than one overflow data storage frame on the page containing this frame reference it can still be difficult for the user to determine the correlation between data storage frames and reading is not made any easier.

### OBJECTS OF THE INVENTION

The present invention is directed to addressing and overcoming the aforementioned problems. Accordingly, an object of this invention is to provide a digital content production system, a digital content production program, and a digital content production method which makes the correlation between data storage frames clear and thus makes following and reading the output digital content easier when producing digital content for output by segmenting and storing the included information in different data storage frames.

### SUMMARY OF THE INVENTION

To achieve this object a digital content production system according to one aspect of the present invention is provided. The system comprises content production means for determining an output layout for selected digital content and producing the selected digital content for output, the content production means segmenting and storing included information of the selected digital content in different ones of a plurality of data storage frames placed in a layout area to produce the digital content for output, wherein the content production means appends related identification information to each data storage frame in which the included information is stored.

Once the digital content is selected the content production means writes the information included in the selected digital content (the “included information”) to multiple data storage frames placed in the layout area, thereby producing the digital content for output.

When the included information is segmented and written to different data storage frames in the layout process, the content production means also adds related identification information to the data storage frames storing the included information segments.

This identification information can be visually recognizable information such as a character, drawing, code, symbol, or color, sound or other type of information recognizable using the five senses, or any combination of such information types.

The identification information added to two or more related data storage frames must only be information that is distinguishable and related, and the relation can be two-way or one-way. For example, if the included information will be referenced in both directions from the point at which the information is segmented, identification information that is bi-directionally relational is preferable. However, if due to the type of included information it is anticipated that the reader will only reference the information in one direction, such as from a first block to a second block or from the second block to the first block but not both ways, then identification information with a link in one direction can be used.

The included information may be segmented and stored to plural different data storage frames because all included information will not fit in one data storage frame or because the layout or the content of the included information, for example, makes it desirable to segment and write the included information to plural data storage frames.

The data storage frames can be placed in the layout area dynamically when laying out the digital content, for example, or a template (layout definition file) could be produced defining the placement of plural data storage frames in the layout area and the data storage frames placed in the layout area based on this template.

The included information can include text data, image data, and other types of information.

The system of this invention can be implemented as a stand-alone apparatus or as a network system having multiple terminals connected so that they can communicate with each other. If implemented as a network system the system components can be associated with any of the plural terminals insofar as communication between the terminals and components is possible.

The output layout may be a display layout when the digital content for output is produced for presentation on screen, for example, or it could be a print layout when the digital content for output is produced for printing to paper.

According to another aspect of the invention, the digital content production system comprises content storage means for storing digital content; content selection means for selecting digital content from the content storage means; and content production means for determining an output layout for the selected digital content and producing digital content for output, the content production means segmenting and storing included information of the selected digital content in different ones of a plurality of data storage frames placed in a layout area to produce digital content for output, wherein, when the included information cannot be completely stored in a particular data storage frame, the content production means stores overflow information of the included information that could not be stored in the particular data storage frame (overflowing data storage frame) to an overflow data storage frame and appends identification information to the overflowing data storage frame and to the overflow data storage frame identifying the overflowing and overflow data storage frames as related.

Digital content is thus selected from the content storage means by the content selection means. The content production means then writes the included information in the selected digital content to the plural data storage frames in the layout area, and thereby produces the digital content for output.

If the included information will not fit completely into a data storage frame and thus overflows in the layout process, the content production means stores the part of the included information that does not overflow the data storage frame to overflowing (source) data storage frame, stores the overflowing included information to an overflow (destination) data storage frame, and adds relational identification information to the data storage frames.

The content storage means may store the digital content to any type of storage device at any time. It may contain pre-stored digital content, or it may store digital content input from some external source when the system of this invention is running instead of pre-stored content.

The content production means preferably appends to the overflowing data storage frame and to the overflow data storage frame guidance information relating to the location of the other data storage frame, and includes the identification information in the guidance information.

The identification information is thus contained in the guidance information that is added to the overflowing data storage frame and the overflow data storage frame. The identification information is preferably a code.

When thus comprised and the included information of the digital content will not fit in one data storage frame and is therefore segmented and stored in source (overflowing) and destination (overflow) data storage frames, a code denoting the relationship between the source and destination frames is added to each of the related frames.

Preferably in this case the content production means adds the same code as the identification information to the overflowing (source) data storage frame and to the overflow (destination) data storage frame.

Preferably content production means appends different codes to data storage frames that contain unrelated content and that are adjacent to, or within a specific range of, one another. Such distinguishing codes are preferably both different and dissimilar in order to improve code recognition and further clarify the relationship between data storage frames.

Preferably the content production means selects a code from a specific code group so as to increase the likelihood that the same code is not used for more than one group of related data storage frames within a specific range.

Thus, in order to reduce the likelihood of erroneously detecting the correlation between data storage frames, codes are preferably selected from specific code groups so that, as much as possible, the specific range of one code and the specific range of another code do not overlap.

Yet further preferably the content production means selects a code from a specific code group so that fewer code types are used throughout the entire layout area.

Yet further preferably there are plural code groups, each code group containing a plurality of similar codes that are different from the codes in other code groups. The content production means produces digital content for output containing plural page unit layout areas, selects a code from the plural code groups according to code usage on each page, and appends the selected code to the overflowing data storage frame and to the overflow data storage frame.

Each code group preferably contains codes that are similar to each other but different from the codes contained in other code groups. This reduces the likelihood of mistaking the correlation between data storage frames.

Yet further preferably the content production means runs a first code selection process for searching the plural code groups for a code group of which none of the member codes has been used on any page, and selecting a code from the code group retrieved by the search. The content production means of this configuration thus adds the code selected by running the first code selection process to the source and destination frames.

Yet further preferably the content production means runs a second code selection process for selecting from the plural code groups a code that has not been used on any page. The content production means of this configuration thus adds the code selected by running the second code selection process to the source and destination frames.

Yet further preferably the content production means runs a third code selection process for searching the plural code groups for a code group of which none of the member codes has been used on any page on which is placed the overflowing data storage frame or the overflow data storage frame, and selecting a code from the code group found by searching. The content production means of this configuration thus adds the code selected by running the third code selection process to the source and destination frames.

Yet further preferably the content production means runs a fourth code selection process for selecting from the plural code groups a code that has not been used on any page on which is placed the overflowing data storage frame or the overflow data storage frame to which the code is to be added. The content production means of this configuration thus adds the code selected by running the fourth code selection process to the source and destination frames.

Yet further preferably the content production means appends the code selected by the first code selection process when such code is available, appends the code selected by the second code selection process when a code cannot be selected by the first code selection process, appends the code selected by the third code selection process when a code cannot be selected by the second code selection process, or appends the code selected by the fourth code selection process when a code cannot be selected by the third code selection process. Thus, the content production means of this configuration adds the code selected by the first, second, third or fourth code selection process, in that priority, to the source and destination frames.

Yet further preferably the content production means selects a code based on the content of the included information, and appends the selected code to the overflowing data storage frame and to the overflow data storage frame.

In another embodiment of the present invention the identification information used by the digital content production system is color. When thus comprised and when the included information of the digital content will not fit in one data storage frame and is therefore segmented and stored in the source (overflowing) and in the destination (overflow) data storage frames, a color denoting the relationship between source and destination frames is added to each of the related frames.

Preferably, the content production means adds the same color as the identification information to the overflowing data storage frame (source frame) and to the overflow data storage frame (destination frame).

Yet further preferably the content production means adds different colors to data storage frames that contain unrelated content.

While it is sufficient for different colors to be added to the data storage frames that contain unrelated content and that are adjacent or within a certain range of each other, the colors are preferably both different and dissimilar in order to improve color recognition and further clarify the relationship between data storage frames.

Yet further preferably the content production means selects a color from a specific color group so as to increase the likelihood that the same color is not used for more than one group of related storage frames within a specific range. To reduce the likelihood of erroneously detecting the correlation between data storage frames, similar colors are preferably selected from specific color groups so that, as much as possible, the specific range of one color and the specific range of another color do not overlap.

Yet further preferably the content production means selects a color from a specific color group so that fewer color types are used throughout the entire layout area.

Yet further preferably there are plural color groups, each color group containing a plurality of similar colors that are different from the colors in other color groups. The content production means produces digital content for output containing plural page unit layout areas, selects a color from the plural color groups according to color usage on each page, and adds the selected color to the overflowing data storage frame and to the overflow data storage frame. Thus, each color group contains plural colors that are similar to each other but different from the colors contained in other color groups. This reduces the likelihood of mistaking the correlation between data storage frames.

Yet further preferably the content production means runs a first color selection process for searching the plural color groups for a color group of which none of the member colors has been used on any page, and selecting a color from the color group retrieved by the search. The content production means of this configuration thus adds the color selected by running the first color selection process to the source and destination frames.

Yet further preferably the content production means runs a second color selection process for selecting from the plural color groups a color that has not been used on any page. The content production means of this configuration thus adds the color selected by running the second color selection process to the source and destination frames.

Yet further preferably the content production means runs a third color selection process for searching the plural color groups for a color group of which none of the member colors have been used on any page on which is placed the overflowing data storage frame or the overflow data storage frame, and selecting a color from the color group found by searching. The content production means of this configuration thus adds the color selected by running the third color selection process to the source and destination frames.

Yet further preferably the content production means runs a fourth color selection process for selecting from the plural color groups a color that has not been used on any page on which is placed the overflowing data storage frame or the overflow data storage frame. The content production means of this configuration thus adds the color selected by running the fourth color selection process to the source and destination frames.

Yet further preferably the content production means appends the color selected by the first color selection process when such color is available, appends the color selected by the second color selection process when a color cannot be selected by the first color selection process, appends the color selected by the third color selection process when a color cannot be selected by the second color selection process, or appends the color selected by the fourth color selection process when a color cannot be selected by the third color selection process. The content production means of this configuration adds the color selected by the first, second, third or fourth color selection process, in that priority, to the source and destination frames.

Yet further preferably the content production means selects a color based on the content of the included information, and appends the selected color to the overflowing data storage frame and to the overflow data storage frame.

A color is preferably selected by the content production means based on the content of the included information with this configuration, and the selected color is added to the source and destination frames.

Yet further preferably the digital content production system also has a user information storage means for storing user information relating to a user, and the content selection means selects digital content from the content storage means based on user information from the user information storage means. With this configuration the digital content to be distributed is selected by the content selection means from the content storage means based on user information retrieved from the user information storage means. The user information could include, for example, the user's age, sex, hobbies, address, name, or the operating environment of the user terminal.

The user information storage means may store the user information to any type of storage device at any time. It may contain pre-stored user information, or it may store user information input from some external source when the system of this invention is running instead of pre-stored user information.

Yet further preferably the digital content production system also has a user information storage means for storing user information relating to a user, and the content production means determines the output layout for the digital content selected by the content selection means based on user information from the user information storage means.

If the user's age is included in the user information, it is possible, when determining the output layout based on the user information, to select a layout using a relatively large font size if, for example, the user age field indicates an older person. If the user's sex is included in the user information and the sex indicates a female, a layout using a rounded or softer font could be selected, for example. If hobbies are included in the user information, then a layout that looks like a children's magazine, the sports section of a newspaper, or technical documentation, for example, could be selected according to the indicated hobbies.

Likewise, if the user name is included then the user name could be used in the title of the layout, and if the operating environment of the user terminal is included and indicates that only a small amount of RAM is available, then a layout that minimizes the use of large graphics could be used.

Another aspect of the present invention is a digital content production program for running a digital content production process on a device (e.g., a computer) capable of reading and executing the medium. The program comprises instructions for determining an output layout for selected digital content and producing the selected digital content for output; instructions for segmenting and storing included information of the selected digital content in different ones of a plurality of data storage frames placed in a layout area to produce the digital content for output; and instructions for appending related identification information to each data storage frame in which the included information is stored.

With this configuration the device reads the program and runs processes defined by the program to achieve the same operation and effects as the digital content production system described above. The program steps may also be implemented as a digital content production method.

A digital content production program according to a further aspect of the invention runs a digital content production process on a device capable of reading the medium. The program comprises instructions for selecting digital content from storage; instructions for determining an output layout for the selected digital content and producing the selected digital content for output; instructions for segmenting and storing included information of the selected digital content in different ones of a plurality of data storage frames placed in a layout area to produce digital content for output; instructions for storing overflow information of the included information that could not be stored in the particular data storage frame (overflowing data storage frame) to an overflow data storage frame, when the included information cannot be completely stored in a particular data storage frame; and instructions for appending identification information to the overflowing data storage frame and to the overflow data storage frame identifying the overflowing and overflow data storage frames as related.

With this configuration the device reads the program and runs processes defined by the program to achieve the same operation and effects as the digital content production system described above. The program steps may also be implemented as a digital content production method.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is a block diagram showing the configuration of a network system used to implement the present invention;

FIG. 2 is a functional block diagram showing the basic functions of a content distribution terminal according to the present invention;

FIG. 3 is a block diagram showing the configuration of the content distribution terminal;

FIG. 4 shows the data structure of a user profile table;

FIG. 5 shows the data structure of a layout definition file and layout number correspondence table;

FIG. 6 shows part of the data structure of the layout definition file;

FIG. 7 shows the data structure of a flow management table;

FIG. 8 shows the data structure of a symbol registration table;

FIG. 9 shows the data structure of a digital content and category number correspondence table;

FIG. 10 is a flow chart of the user registration process;

FIG. 11 is a flow chart of the content distribution process;

FIG. 12 is a flow chart of the automatic layout process;

FIG. 13 is a flow chart of the process for storing data to a text data storage frame;

FIG. 14 is a flow chart of the process for storing data to a text data storage frame;

FIG. 15 is a flow chart of the data flowing process;

FIG. 16 is a flow chart of the guidance information appending process;

FIG. 17 is a flow chart of the symbol group searching processing;

FIG. 18 is a flow chart of the symbol searching processing;

FIG. 19 is a flow chart of the symbol group searching processing;

FIG. 20 is a flow chart of the symbol searching processing;

FIG. 21 is a flow chart of the process for handling unprocessed flow objects; and

FIG. 22 is a flow chart of the symbol appending process. [Key to the figures]

| | |
|---|---|
| 360 | layout area |
| 362 | title data storage frame |
| 364, 370, 372 | text data storage frame |
| 366, 368 | image data storage frame |

### DESCRIPTION OF THE PREFERRED EMBODIMENTS

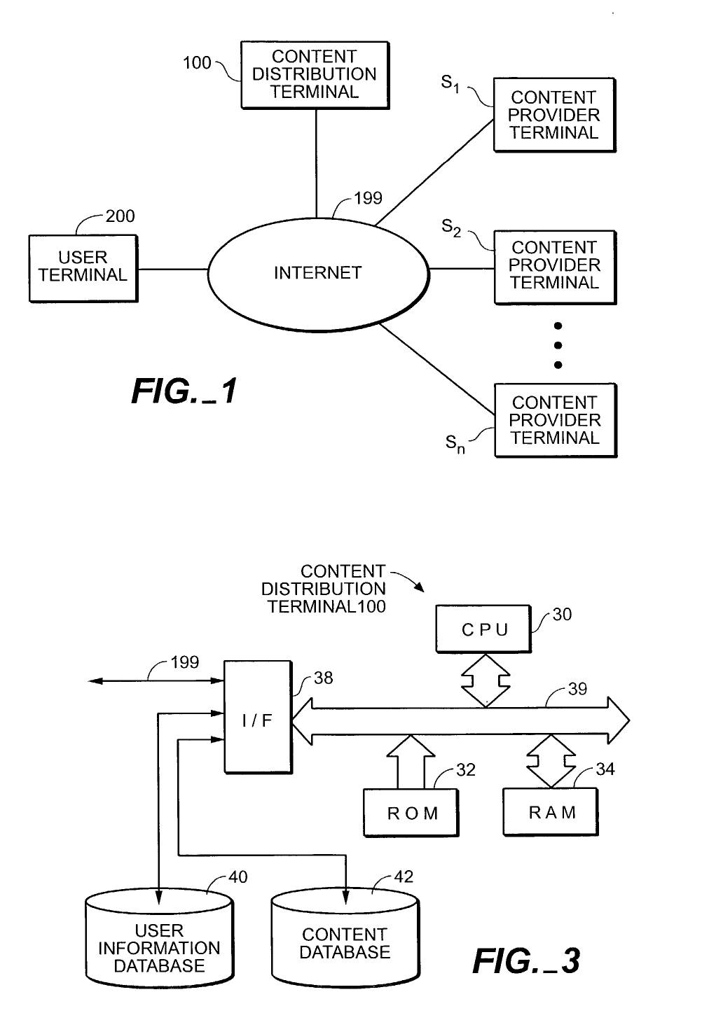

A preferred embodiment of the present invention is described below with reference to the accompanying figures. FIG. 1 to FIG. 21 describe a digital content production system, a digital content production program, and a digital content production method according to the present invention.

The preferred embodiment of a digital content production system, a digital content production program, and a digital content production method according to the present invention can be used for distributing news and other digital content from a content distribution terminal 100 to a user terminal 200 as shown in FIG. 1.

A network system used to deploy the present invention is described first with reference to FIG. 1, which is a block diagram showing the configuration of a network system over which the present invention can operate. As shown in FIG. 1 a plurality of content provider terminals Si to Sn for providing digital content, a content distribution terminal 100 for collecting, storing, and distributing digital content provided by the content provider terminals Si to Sn, and a user terminal 200 enabling a user to access the digital content are connected to the Internet 199. It should be noted that only one user terminal 200 is shown in FIG. 1 to simplify describing the present invention, but in actuality numerous user terminals are connected to the Internet 199.

The content provider terminals Si to Sn have the same functions and configuration as a general-purpose computer having a CPU, ROM, RAM, and interfaces connected via buses. When producing digital content, a category number for identifying the digital content category is added to the digital content and transmitted to the content distribution terminal 100. These category numbers are described in detail further below.

The user terminal 200 also has the same functions and configuration as a general-purpose computer having a CPU, ROM, RAM, and interfaces connected via buses. It also has a browser for browsing the World Wide Web (WWW) (referred to as a “web browser” below), and can access the content distribution terminal 100 via the web browser.

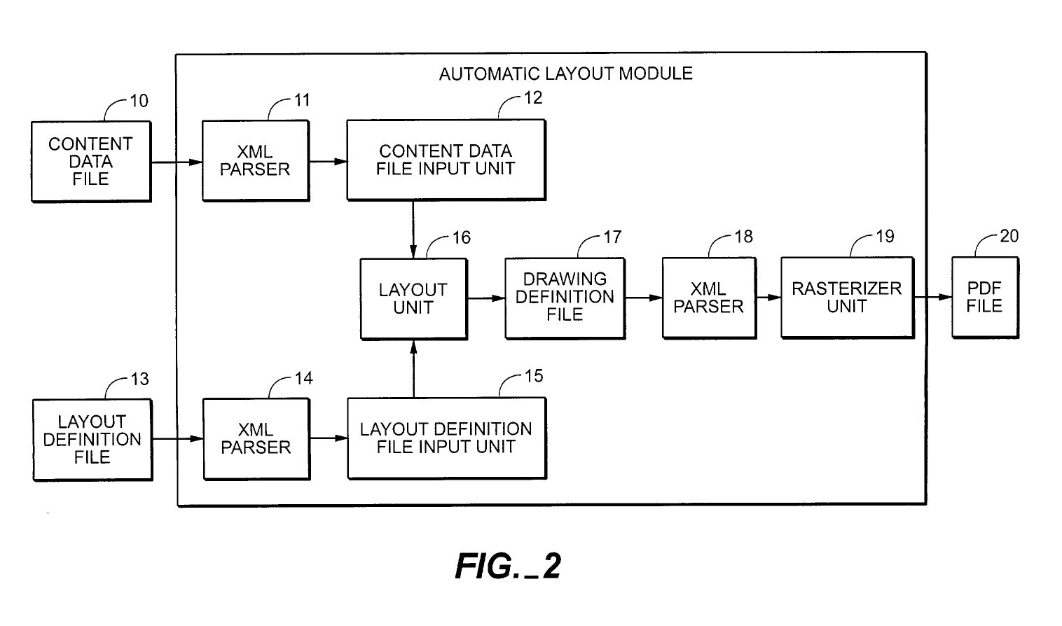

Essential functions of the content distribution terminal 100 are described next in detail with reference to FIG. 2, which is a functional block diagram showing a summary of the functions of the content distribution terminal 100. As shown in FIG. 2, the content distribution terminal 100 has an XML parser 11 for parsing an XML (extensible Markup Language) format content data file 10, a content data file input unit 12 for inputting the content data file 10 parsed by XML parser 11, an XML parser 14 for parsing an XML format layout definition file 13, a layout definition file input unit 15 for inputting the layout definition file 13 parsed by XML parser 14, a layout unit 16 for making a layout based on the content data file 10 and layout definition file 13 input by the input units 12 and 15, an XML parser 18 for parsing an XML format drawing definition file 17 output from the layout unit 16, and a rasterizer unit 19 for creating a PDF (Portable Document Format) file 20 by drawing according to the drawing definition file 17 parsed by the XML parser 18. It should be noted that this embodiment of the invention is particularly directed to the layout unit 16 in this configuration.

The content distribution terminal 100 is described in further detail next with reference to FIG. 3, which is a block diagram showing the configuration of the content distribution terminal 100. As shown in FIG. 3 the content distribution terminal 100 has a CPU 30 controlling the overall system and operations based on a control program, ROM 32 for storing the control program at a preassigned address, RAM 34 for storing data read from ROM 32 and the required results of operations performed by the CPU 30, and an interface 38 for handling data input/output from and to an external device. These components are connected to a data transfer signal bus 39 enabling communication between these other devices.

A user information database 40 for storing user data, a content database 42 for collecting and storing digital content supplied from the content provider terminals Si to Sn, and a signal path for connecting to the Internet 199 are connected to the interface 38 as external devices.

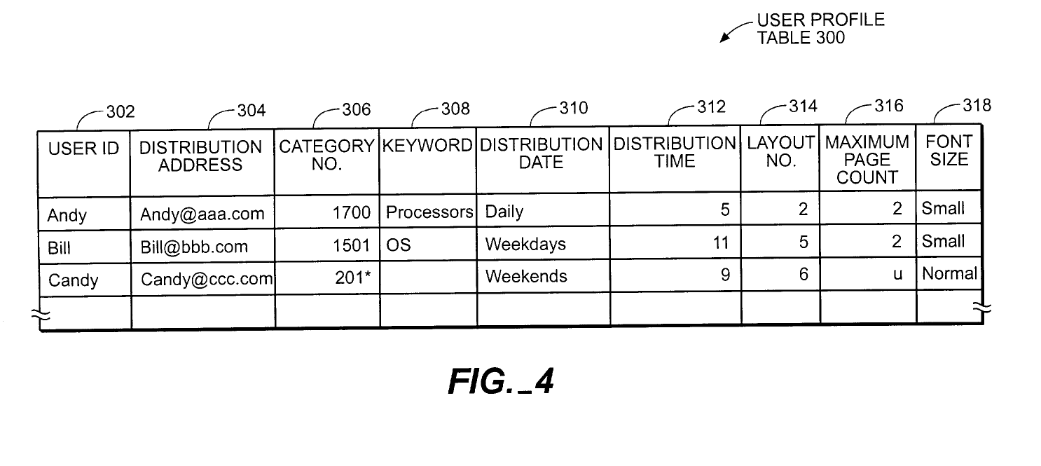

The data structure of the user information database 40 is described next in detail with reference to FIG. 4. As shown in FIG. 4, a user profile table 300 for storing user information is stored to the user information database 40. FIG. 4 shows the data structure of this user profile table 300.

The user profile table 300 can store one or multiple records for each user. Each record includes a user ID field 302 for storing a user ID identifying a unique user record, a distribution address field 304 for storing the address to which digital content is sent, a category number field 306 for storing a category number, a keyword field 308 storing a search keyword, a distribution date field 310 for storing a distribution date, a distribution time field 312 for storing the time of content distribution, a layout number field 314, a maximum page count field 316 for storing the maximum number of pages, and a font size field 318 for storing a font size preference.

The keyword field 308 stores a keyword specified by the user for selecting digital content for distribution to the user. Terms that frequently appear in articles in the category of interest to the user, for example, are used as keywords. In the example in FIG. 4 the keyword stored for the user in the first row of the keyword field 308 is “processors,” and the keyword for the user in the second row is “OS” (operating systems).

The distribution date field 310 stores the distribution date preferred by the user for digital content distribution. If, for example, the user wants to receive the digital content everyday, “daily” is selected; “weekdays” is selected if the user wants to receive content only on weekdays; and “weekends” is selected to receive distribution only on weekends. “Daily” is stored in the first record in the example in FIG. 4, “weekdays” in the second record, and “weekends” in the third record.

The distribution time field 312 stores the preferred time of digital content distribution on the days specified by the user. In this example time is expressed using a 24 hour time system and any time ranging from 0:00 to 23:00 can be specified. In the example in FIG. 4 a time of 5:00 is stored in the distribution time field 312 in the first record and a time of 11:00 is stored in the second record.

The layout number field 314 stores a layout number specifying the digital content output layout. The layout number is the number of the layout identifying the output layout preferred by the user. Layout number 2 and layout number 5 are stored in the first and second records, respectively, in the layout number field 314 in the example in FIG. 4. The layout number is described in further detail below.

The maximum number of digital content pages to be displayed or printed is stored in the maximum page count field 316. The maximum page count can be specified as a certain desired number, or as “u” to indicate that no upper limit is set. The maximum page count is 2 pages in the first record, and “u” or no upper limit is set for the third record in the maximum page count field 316 in FIG. 4.

The font size field 318 stores the font size preferred by the user for displaying or printing the digital content. In the example in FIG. 4 “small” is stored in the first record in font size field 318 and “normal” is stored in the third record.

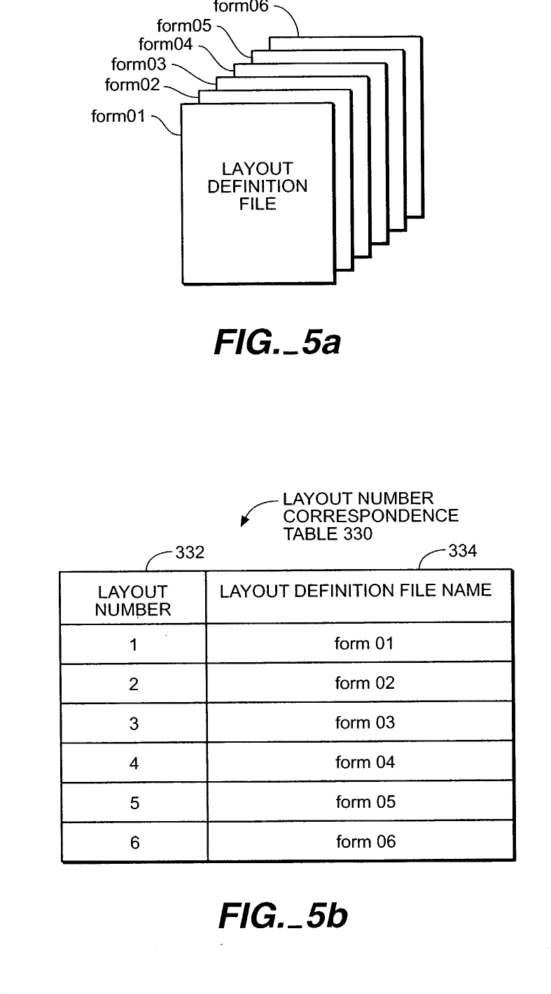

As shown in FIG. 5(a) the user information database 40 also stores multiple layout definition files labelled form01 to form06 defining the digital content output layout, and a layout number correspondence table 330 defining the correlation between the multiple layout definition files (form01 to form06) and their layout numbers. FIG. 5(b) shows the data structure of the layout definition file and layout number correspondence table 330.

The layout definition files form01 to form06 are written in XML, for example, and define the size and placement on the printing paper of text data storage frames for holding text data and images contained in the digital content, the text data font size, type, and color, character spacing and line pitch, and the number, quality, size, and percentage of images.

As shown in FIG. 5(b), the layout number correspondence table 330 stores one record per layout number. Each record has a layout number field 332 and a layout definition file name field 334. In the example in FIG. 5(b) layout number “1” and layout definition file name “form01” are stored in the first record, and layout number “2” and layout definition file name “form02” are stored in the second record.

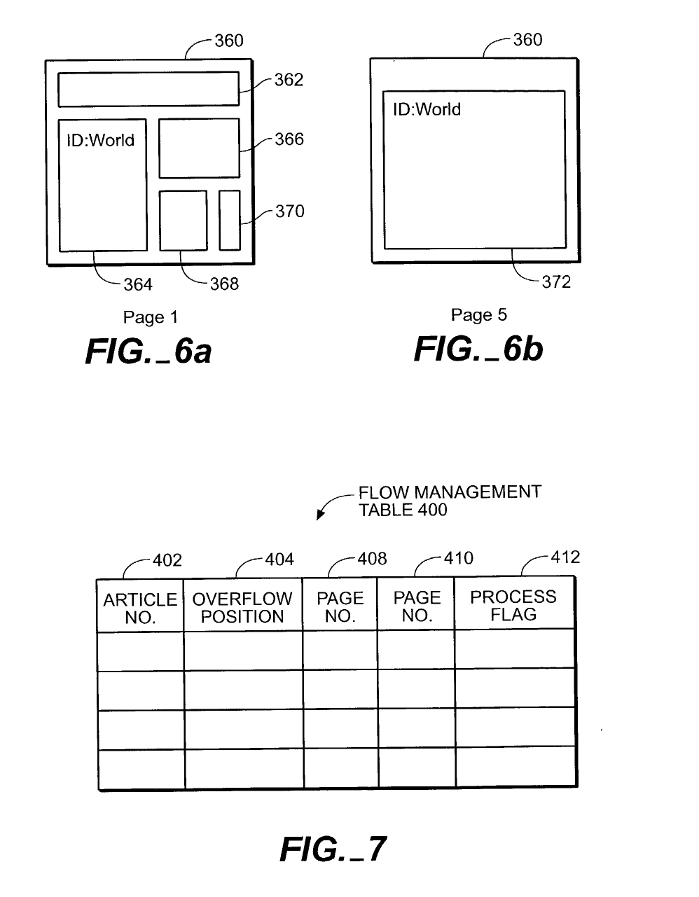

The data structure of the layout definition files form01 to form06 is described in detail next. FIG. 6 shows part of the layout definition file data structure. Each layout definition file form01 to form06 has a different data structure, and the structures of some typical layout definition files are described here.

Layout definition file formOl has a layout area 360 on each page. As shown in FIG. 6(a), the layout area 360 of page 1, for example, has a title data storage frame 362 for storing a title, text data storage frames 364 and 370 for storing text data, and image data storage frames 366 and 368 for storing images. In this example “World” is assigned as the identifier for text data storage frame 364. Note that data storage frames are also referred to as simply “frames” below.

The layout area 360 of page 5, for example, has a single text frame 372 as shown in FIG. 6(b). The same identifier (“World”) assigned to text data storage frame 364 is assigned to this text frame 372. Text frames 364 and 372 are linked by this ID, indicating that when the text data will not fit and thus overflows from text data storage frame 364 the overflowing text flows into and is stored to text frame 372. Note that the text or other information that will not fit into the data storage frame of the current page or previous page and thus overflows into a different frame is referred to herein as a “flow object.” It should be noted that text data storage frames are identified and linked by an assigned ID in the example shown in FIG. 6, but the invention shall not be so limited. For example, an unused text data storage frame can be used as the text data storage frame for storing a particular flow object during the layout process.

Furthermore, a flow management table 400 for managing flow objects is generated and stored in the user information database 40 as shown in FIG. 7 during the digital content layout process. FIG. 7 shows the data structure of the flow management table 400.

As shown in FIG. 7, the flow management table 400 stores one record for each flow object. Each record has an article number field 402 for storing an article number identifying a unique flow object, an overflow position field 404 for storing the beginning of a text data flow object (overflow position), a page number field 408 storing the page number of the text data storage frame where the flow object starts (the page number from which the data overflows), a page number field 410 storing the page number of the text data storage frame storing the end of the flow object (the number of the page storing the overflow), and a process flag field 412 storing a flag denoting whether the flow object is unprocessed.

It should be noted that the flow management table 400 is compiled dynamically while processing layouts and is stored in the user information database 40 in the present embodiment, but the invention shall not be so limited. The flow management table 400 could, for example, be compiled in RAM 34 during layout processing without being stored to user information database 40.

Flow objects are processed in FIFO (first in, first out) order with flow management table 400. That is, a record is added to the end of the flow management table 400 for a flow object overflowing a frame for the first time, and unprocessed flow objects are processed in sequence from the beginning of the flow management table 400. If as the result of processing an unprocessed flow object the flow object cannot be completely stored in the new data storage frame and thus overflows again, a record for that flow object is exceptionally stored at the beginning of the flow management table 400. This is to prevent article content from being dispersed across a wide range of pages by storing the objects at the beginning and preferentially processing those objects.

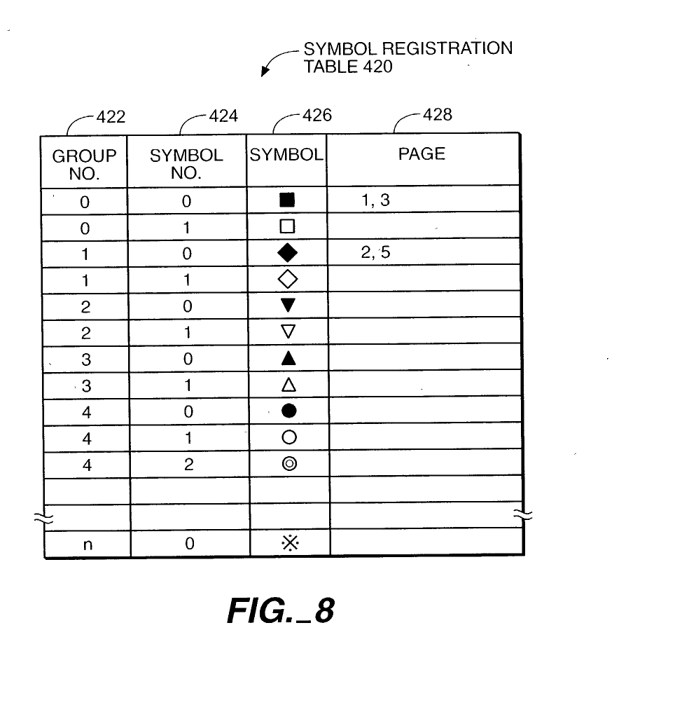

A symbol registration table 420 as shown in FIG. 8 is also stored to the user information database 40. This symbol registration table 420 stores symbols added to the overflowing data storage frames and overflow data storage frames to clearly identify the correlation between the overflowing data storage frame storing text data other than a flow object and overflow data storage frames storing the flow object when text data will not completely fit in a particular text frame. FIG. 8 shows the data structure of the symbol registration table 420.

The symbols added to the overflow frames and overflowing frames are first grouped into multiple symbol groups. Each symbol group contains plural symbols different from the symbols of other symbol groups, and the symbols in each group are similar to other symbols in the same group. The member symbols of each symbol group are also preferably as dissimilar as possible to the symbols of other symbol groups.

Based on this rule, the symbol registration table 420 records one record per symbol as shown in FIG. 8. Each record has a group number field 422 for recording a group number identifying a symbol group, a symbol number field 424 for recording a symbol number identifying a particular symbol in the symbol group, a symbol field 426 for recording a symbol, and a page field 428 recording the page numbers of the pages on which the symbol stored in the symbol field 426 is used.

It should be noted that the symbol registration table 420 is compiled dynamically during layout processing and is therefore preferably stored in the user information database 40 in the present embodiment, but the invention shall not be so limited and it could be generated in RAM 34 during layout processing without being stored in the user information database 40.

In the example shown in FIG. 8 the symbol group identified by symbol number 0 contains the two symbols ▪ and □, the symbol group identified by symbol number 2 contains the two symbols ▾ and ∇, and the symbol group identified by symbol number 4 contains the three symbols ●, ο, and ⊚.

The data structure of the content database 42 is described in detail next.

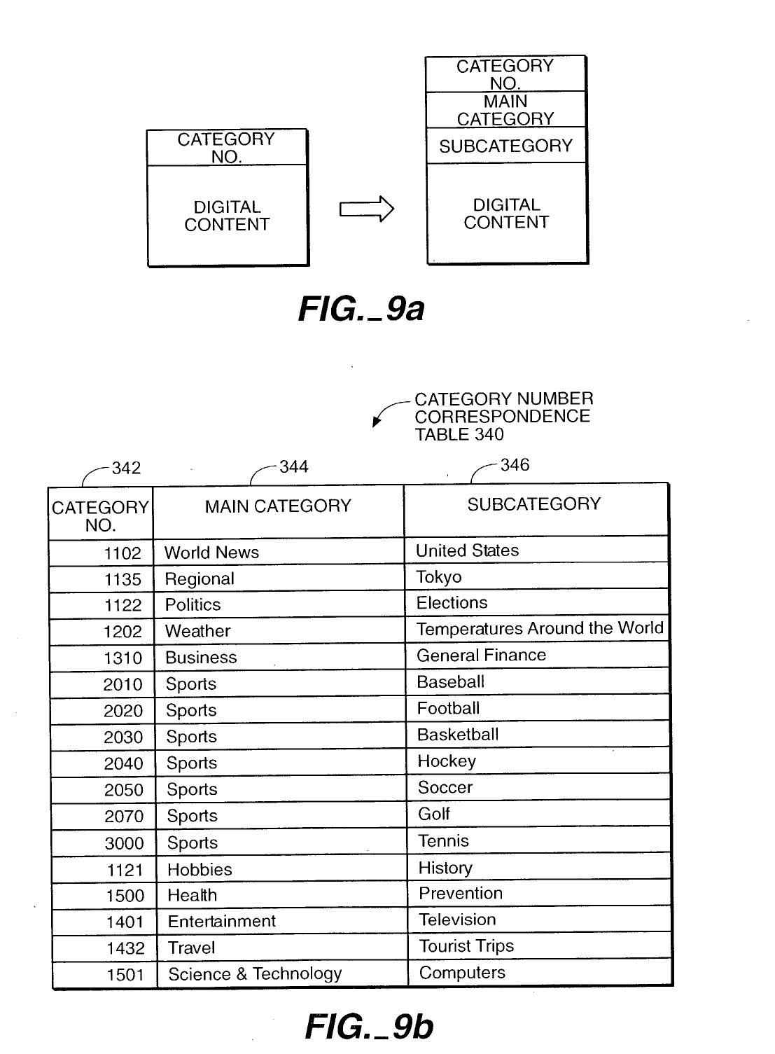

As shown in FIG. 9 digital content supplied from the content provider terminals S₁ to Sₙ and a category number correspondence table 340 correlating main categories, subcategories, and category numbers, are stored to the content database 42. FIG. 9 shows the data structure of the digital content and the category number correspondence table 340.

As shown in FIG. 9(a) an article number and category number are assigned to the digital content supplied from the content provider terminals S₁ to Sₙ. The content distribution terminal 100 groups and stores digital content in the content database 42 according to category based on these category numbers. When storing the digital content the category number correspondence table 340 is referenced to assign and store with the digital content a main category and subcategory in addition to the article number and category number. Digital content is recorded as articles including title information indicating the title of the article, image information relating to images in the article, and text data containing the text of the article.

The category number correspondence table 340 stores one record for each main category and subcategory combination as shown in FIG. 9(b). Each record has a category number field 342, main category field 344, and subcategory field 346. For the category number “1102,” the main category is “world news,” and the subcategory is “United States” in the first record of this sample category number correspondence table 340 as shown in FIG. 9(b); for the category number “2010,” the main category is “sports,” and the subcategory is “baseball” in the sixth record.

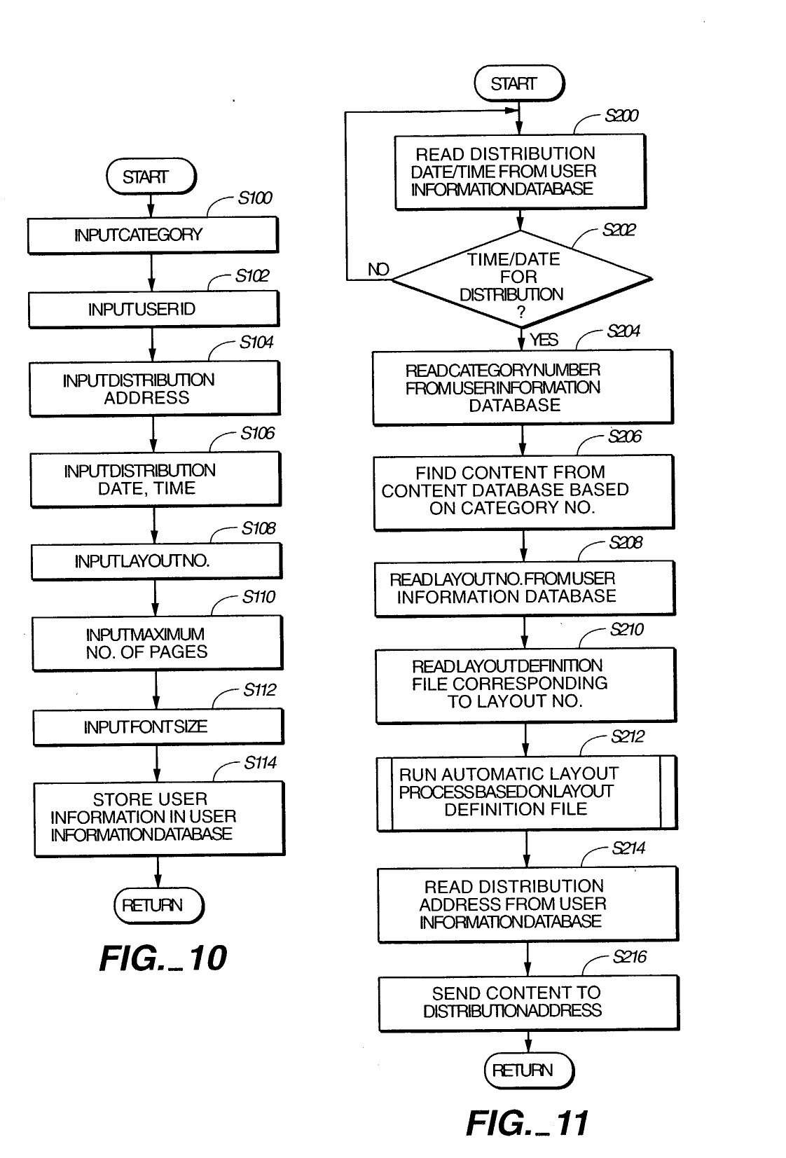

The configuration of the CPU 30 and the process run by the CPU 30 are described next with reference to FIG. 10 and FIG. 11. The CPU 30 is a microprocessor that activates a specific program stored at a specific address in ROM 32 enabling time-division processing of the user registration process and content distribution process shown in FIG. 10 and FIG. 11.

The user registration process is described first in detail with reference to the flow chart thereof in FIG. 10. The user registration process requests input of a user ID and other required user information from any user accessing the system, and records the input user information in the user profile table 300. When the user registration process is run by the CPU 30 it starts from step S100 as shown in FIG. 10. It should be noted that input in each of the steps described below is accomplished through an interactive dialog with the user.

The main category and subcategory are input in step S100, the user ID and password are input in step S102, the distribution address is input in step S104, and the distribution date and time are input in step S106. The layout number is then input in step S108, the maximum page count is input in step S110, and the font size is input in step S112. The user information input in steps S100 to S112 is then recorded in the user profile table 300 in step S114, the user registration process ends, and operation returns to the previous process.

The content distribution process is described next in detail with reference to the flow chart thereof in FIG. 11. The content distribution process references the user profile table 300 and distributes digital content to the user terminal 200. The process run by the CPU 30 starts from step S200 as shown in FIG. 11. Note that each step in the process is applied to one record of the user profile table 300. In practice each step is run the same number of times as there are records in the user profile table 300.

The distribution date and distribution time are read from the user profile table 300 in step S200, and whether it is the time and date to distribute digital content is then determined based on the read distribution date and time in step S202. The process proceeds to step S204 if it is the time and date for digital content distribution (step S202 returns yes), and otherwise loops back to step S200.

After proceeding through the “yes” terminal of step S202, the category number is then read from the user profile table 300 in step S204. The content database 42 is then searched for digital content based on this category number in step S206 and digital content with a matching category number is retrieved.

The layout number is then read from the user profile table 300 in step S208. The layout number correspondence table 330 is then referenced in step S210 to read the layout definition file corresponding to the read layout number from the user information database 40. An automatic layout process for determining the output layout for the digital content retrieved in step S206 based on the read layout definition file and producing digital content for distribution is then run in step S212. When this layout process ends the procedure advances to step S214.

The distribution address is then read from the user profile table 300 in step S214, and the digital content compiled in step S212 is then sent to the distribution address in step S216 to complete the process. Control then returns to the previous operation.

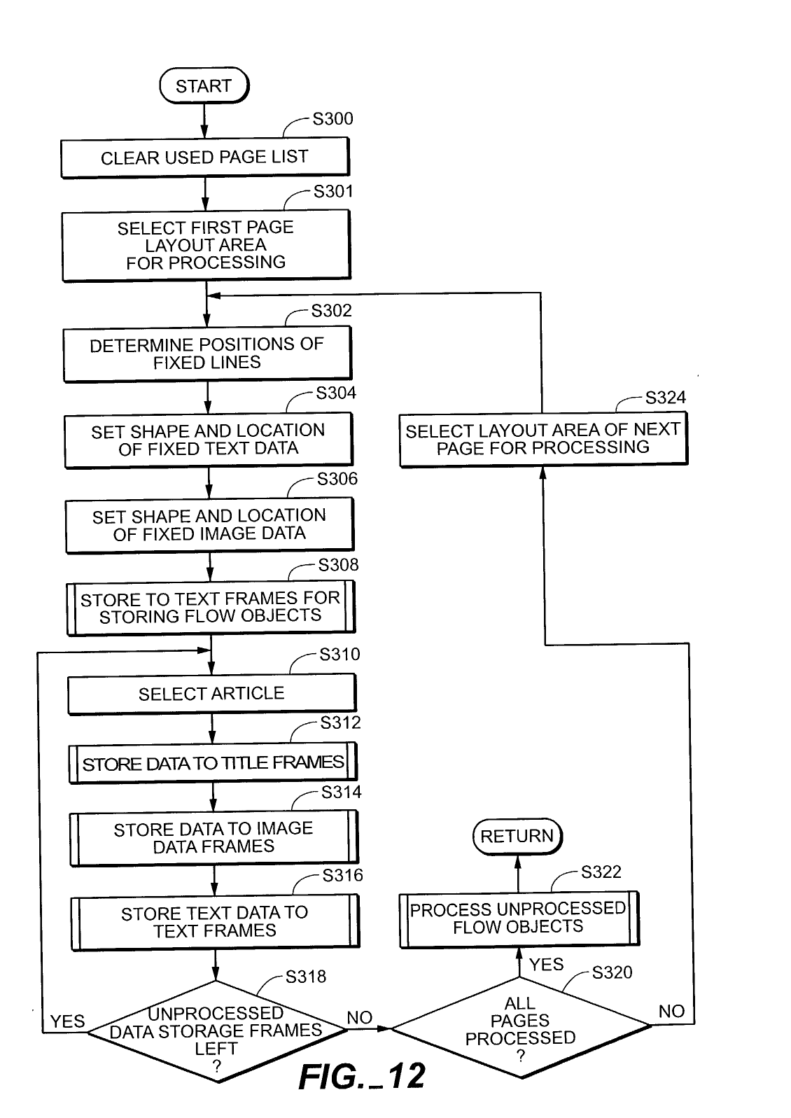

The automatic layout process run in step S212 above is described in detail next below with reference to FIG. 12, a flow chart of the automatic layout process. When the automatic layout process starts in step S212 operation proceeds from step S300 as shown in FIG. 12.

The page field 428 is cleared for all records in the symbol registration table 420 in step S300, and the layout area 360 in the first page of the layout definition file read in step S210 is set as the process object. The location of a fixed line at a fixed position on the page is then determined (step S302), the shape and location of fixed text data at a fixed position on the page are determined (step S304), and the shape and location of fixed images at a fixed position on the page are determined (step S306).

A routine for determining the shape and location of a text frame for storing a flow object and then storing the flow object in that text frame is then run in step S308. Based on a specific order of precedence the article to be placed in layout area 360 is selected from the digital content found in step S206 (step S310).

A routine for determining the shape and location of the title frame based on the article selected in step S310 and placing the title data contained in the selected article in that title frame is then run in step S312. In step S314 a routine is run for determining the shape and location of image data frames based on the selected article and placing the image data contained in the selected article in the image frame. Next in step S316 a routine is run for determining the shape and location of text data frames based on the selected article and placing the text data contained in the selected article in the text frame.

Whether there are any unprocessed data storage frames in the layout area 360 is then determined in step S318. If there are no unprocessed data storage frames (step S318 returns no) it is determined in the next decision step S320 whether steps S302 to S318 have been completed for all pages in the layout definition file read in step S210. If all pages have been processed (step S320 returns yes), a routine for placing unprocessed flow objects is run in step S322. Completion of step S322 ends the automatic layout process, and control returns to the previous process.

If it is determined in step S320 that all pages in the layout definition file read in step S210 have not been processed (step S320 returns no), control passes to step S324. The next page of the layout area 360 in the layout definition file read in step S210 is then set as the process object and the procedure loops back to step S302.

If it is determined in step S318 that there are remaining unprocessed data storage frames in the layout area 360 (step S318 returns yes), control loops back to step S310.

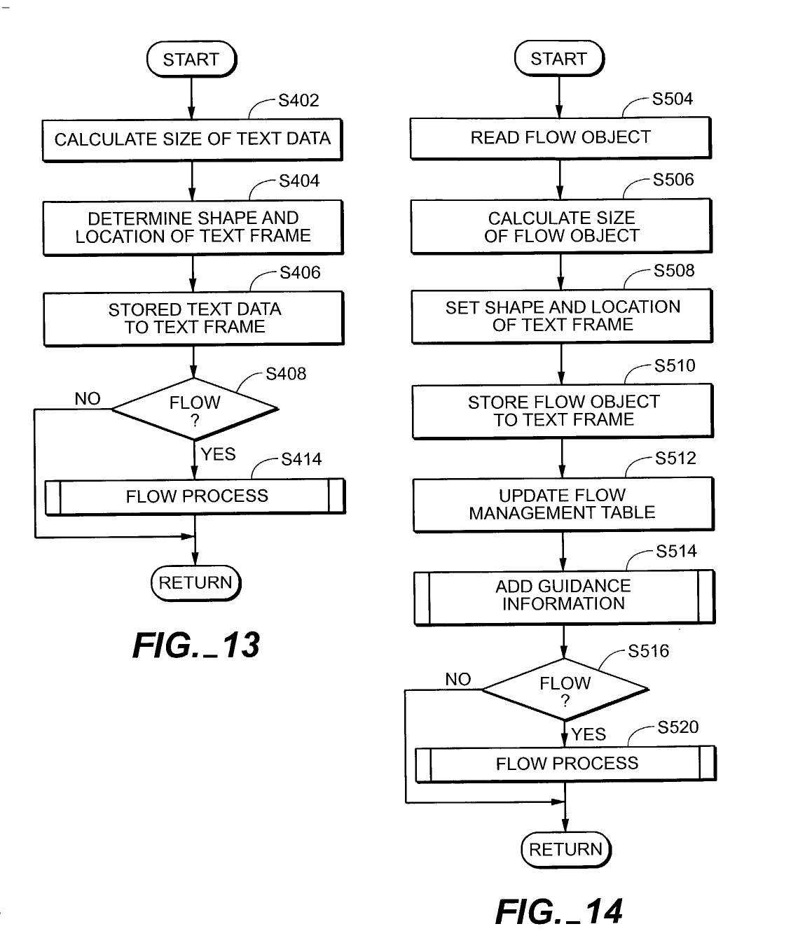

The routine run in step S316 for storing data in a text frame is described in detail next with reference to the flow chart thereof shown in FIG. 13. The routine for storing data in a text data storage frame is a process for filling new text data into a text frame. When this routine is run in step S316 it starts from step S402 as shown in FIG. 13.

The amount of text data in the selected article is calculated in step S402. Based on the calculated text volume the shape and position of the text frame are determined in step S404. More specifically, the shape and location of the text frame are determined so that the text frame does not overlap another data storage frame for which the shape has already been determined. If the text frame will overlap another data storage frame for which the shape is already set, the text frame is moved or reshaped in a movable direction so that it will not overlap the other frame. To avoid disturbing the layout intended by the designer, the text frame is preferably reshaped or moved as little as possible. The direction for frame reshaping and movement can be determined dynamically or predefined.

After the shape and position of the text frame are thus determined, the text data in the selected article is then written to the text frame in step S406.

Whether the text data in the selected article all fits into the defined text frame is then determined in step S408. If it does (step S408 returns no indicating that the text does not flow into another frame), the text storage routine ends and control returns to the calling procedure.

If the text does not fit in the frame (step S408 returns yes indicating that the text flows into another frame), a text overflow routine is applied to the flow object in step S414, the text storage routine then ends and control returns to the previous procedure.

The routine for storing data to a text data storage frame that is run as step S308 above is described next in detail with reference to the flow chart thereof shown in FIG. 14. This text data storage routine stores a flow object to a text frame. When step S308 is run it starts from step S504 as shown in FIG. 14.

The corresponding record is referenced to read the flow object in step S504, and the size of the read flow object is then calculated in step S506. The shape and location of the text frame are then determined based on the calculated data size (step S508), the flow object is written to the text frame in step S510, and the flow management table is updated in step S512.

More specifically, the stored page number of the flow object is set to the current page number in the corresponding record and the process flag is set in step S512. A routine for adding guide information relating to the placement of other data storage frames to the overflowing text frame and the overflow text frame is then run in step S514.

Whether the flow object all fits into the text frame is then determined in step S516. If it does (step S516 returns no indicating that the object does not flow into another frame), the storage routine ends and control returns to the calling procedure.

If the object does not fit in the frame (step S516 returns yes indicating that the object flows into another frame), an overflow routine is applied to the flow object in step S520, the storage routine then ends and control returns to the calling procedure.

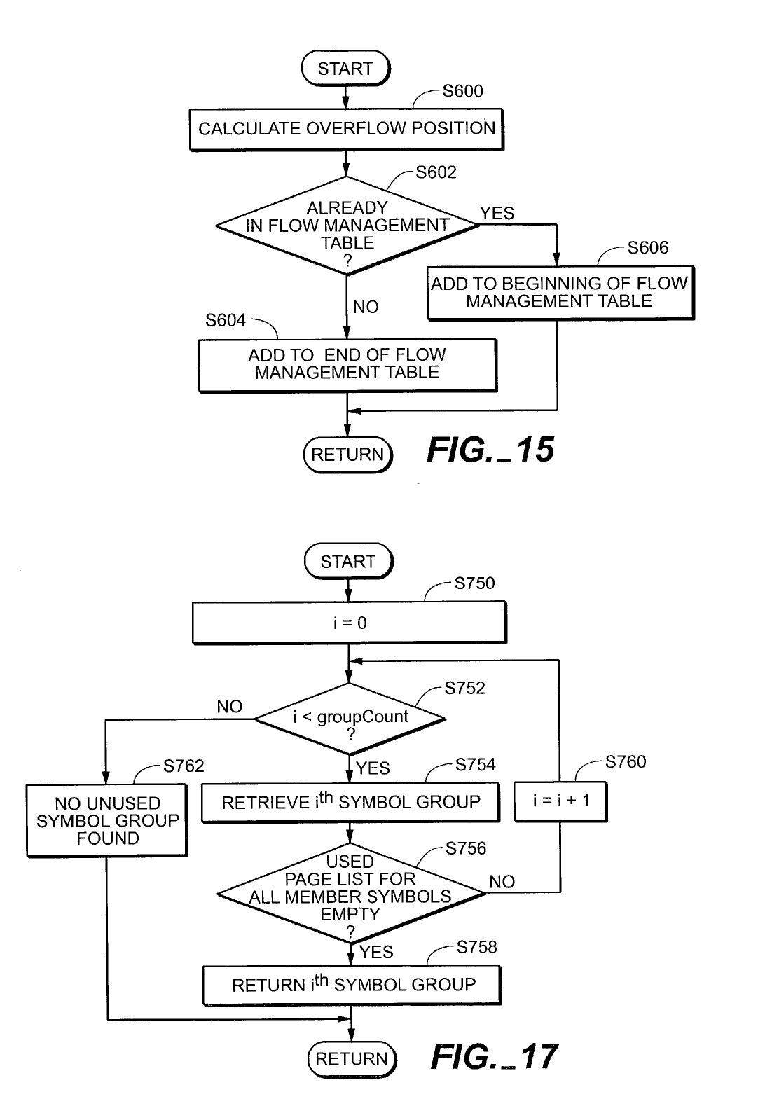

The overflow routine run in steps S414 and S520 above is described in detail next with reference to the flow chart thereof in FIG. 15.

When the overflow routine is run in step S414 or S520 it starts from step S600 as shown in FIG. 15. The beginning of the flow object in the text data is calculated first in step S600. Whether there is a record in the flow management table 400 in which the article number is the same and the process flag is not set is then determined (step S602). If there is no such record (step S602 returns no), a record is generated for the flow object and written to the end of the flow management table 400 (step S604).

More specifically, the article number of the flow object is written to the article number field 402, the starting position determined in step S600 is written to the overflow position field 404, the current page number is written to the page number field 408, and the process flag is cleared to create the flow object record. This same operation is performed in step S606.

The overflow routine then ends and control passes back to the previous routine.

If there is a record in the flow management table 400 storing the same article number and a cleared process flag (step S602 returns yes), control passes to step S606 and a record is generated for the flow object as described above. The same routine run in step S514 is then applied to this record, and the generated record is written to the beginning of the flow management table 400. The overflow routine then ends and control passes back to the previous routine.

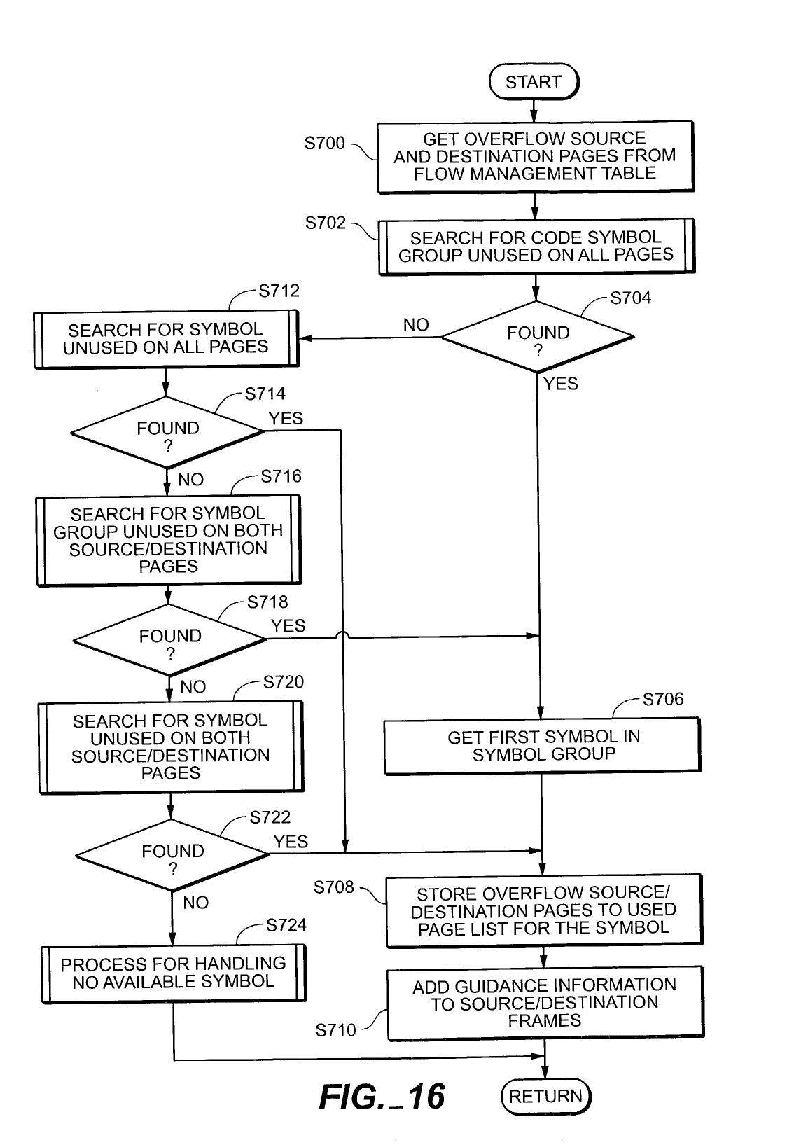

The routine for adding guidance information run as step S514 above is described in detail next with reference to the flow chart thereof shown in FIG. 16. When the guidance information process is run in step S514 it starts from step S700 as shown in FIG. 16.

The page on which the overflowing text frame is located (the “source page” below) and the page on which the overflow text frame is located (the “destination page” below) are retrieved from the corresponding record in the flow management table 400 (step S700).

The symbol registration table 420 is then searched for a symbol group of which all member symbols are unused on all pages (step S702), and whether such a symbol group was found is then determined in step S704. If a corresponding symbol group was found (step S704 returns yes), the first symbol in the selected symbol group is retrieved from the symbol registration table 420 in step S706.

The source page and destination page are then recorded in the page field 428 (the “used page list” below) of the selected symbol record (step S708). Guidance information including the selected symbol is then added to the overflowing text frame and the overflow text frame (step S710), the routine then ends, and control returns to the previous process.

More specifically in step S710, guidance information relating to the location of the overflow text frame and including the selected symbol is generated, and the guidance information is added to the overflowing text frame. Guidance information relating to the location of the overflowing text frame and the selected symbol is also generated and added to the overflow text frame.

This guidance information includes the page numbers, for example, of the overflowing and overflow text frames, as well as the position on the page of the overflowing text frame or overflow text frame, that is, whether the frame is in the upper right part of the page or the lower left part, for example.

If an unused symbol group, that is, a symbol group having no member symbols used on any page, is not found in step S702 (step S704 returns no), the symbol registration table 420 is searched for a symbol that is not used on any page (step S712). Whether an unused symbol was found is then determined (step S714). If an unused symbol was found (step S714 returns yes), control skips to step S708.

If an unused symbol cannot be found (step S714 returns no), the symbol registration table 420 is searched in step S716 for a symbol group having no member symbols used on either the source page or the destination page. Whether such a symbol group was found is then determined in step S718. If such a symbol group was found (step S718 returns yes), control skips to step S706.

If a symbol group unused on the source page and destination page could not be found (step S718 returns no), the symbol registration table 420 is searched for a symbol that is not used on the source page and destination page (step S720). Whether such an unused symbol was found is then determined (step S722), and if it was (step S722 returns yes) control passes to step S708.

If such an unused symbol could not be found (step S722 returns no), a routine for handling cases in which a symbol could not be found is run (step S724), the procedure then ends, and control returns to the previous process.

The routine run in step S724 could, for example, add guidance information not containing a symbol to the overflowing text frame and overflow text frame, or it could add guidance information containing a special symbol not belonging to any symbol group.

The symbol group search routine run in step S702 is described in detail next with reference to the flow chart thereof shown in FIG. 17.

When this search routine is run in step S702 it starts from step S750 as shown in FIG. 17. The search routine starts by initializing counter variable i to 0 in step S750. The counter variable i is then compared with the variable groupCount in step S752. Variable groupCount stores the total number of symbol groups. If counter variable i is less than groupCount (step S752 returns yes), the symbol group with the group number indicated by counter variable i is retrieved in step S754 and control steps to step S756.

Whether the used page list (that is, page field 428) is blank for all symbols in the symbol group is determined in step S756. If the used page list is blank for all symbols (step S756 returns yes), the symbol group with the group number indicated by counter variable i is returned to the previous process, the procedure then ends, and control returns to the previous process.

If the used page list is not blank for any symbol in the selected symbol group (step S756 returns no), counter variable i is incremented by 1 (step S760) and control loops back to step S752.

If the counter variable i is greater than or equal to groupCount in step S752 (step S752 returns no), the calling process is informed that there is no symbol group of which all member symbols are unused on all pages (step S762), the procedure then ends, and control returns to the previous process.

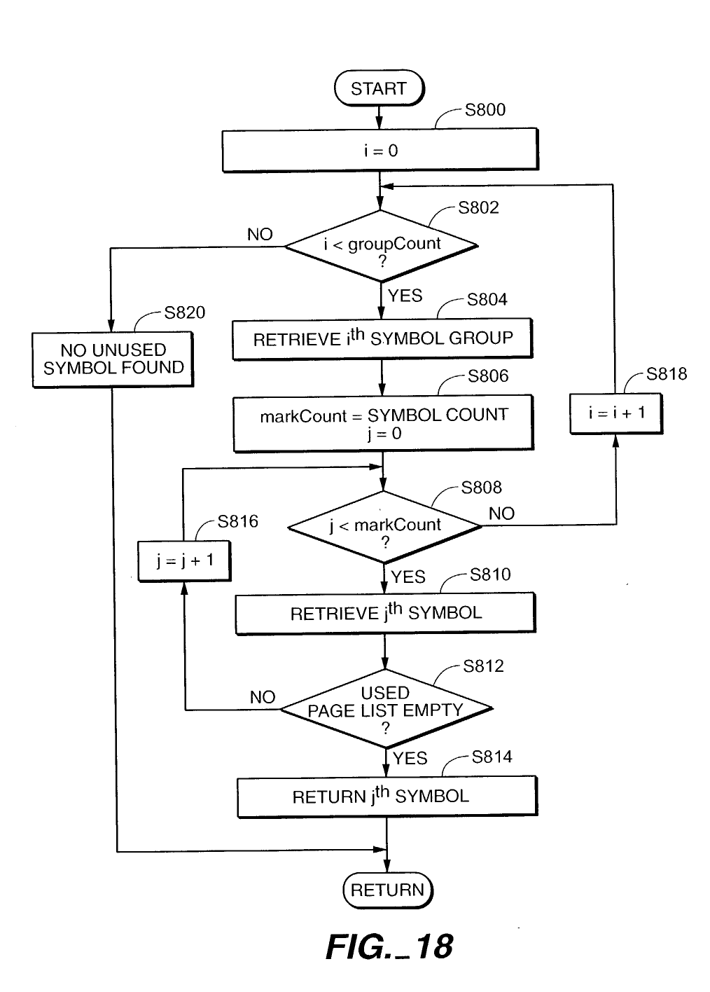

The symbol search routine run in step S712 is described in detail next with reference to the flow chart thereof shown in FIG. 18. This search routine starts from step S800 as shown in FIG. 18 by initializing counter variable i to 0. The counter variable i is then compared with the variable groupCount in step S802. If counter variable i is less than groupCount (step S802 returns yes), the symbol group with the group number indicated by counter variable i is retrieved in step S804.

The total number of symbols in the retrieved symbol group is then set to variable markCount, and counter variable j is initialized to 0 in step S806. The value of counter variable j is then compared with markCount in step S808. If counter variable j is less than markCount (step S808 returns yes), the symbol with the symbol number indicated by counter variable j is retrieved in step S810.

Whether the used page list is empty for the retrieved symbol is then determined (step S812). If it is (step S812 returns yes), the symbol with the symbol number indicated by counter variable j is returned to the calling process (step S814), the procedure then ends, and control returns to the previous process.

However, if the used page list is not empty for the retrieved symbol (step S812 returns no), the counter variable j is incremented by 1 in step S816, and control loops back to step S808.

If in step S808 the counter variable j is greater than or equal to markCount (step S808 returns no), counter variable i is incremented by 1 in step S818, and control loops back to step S802.

If in step S802 the counter variable i is greater than or equal to groupCount (step S802 returns no), the calling process is informed that there are no symbols that are unused on all pages in step S820, the procedure then ends, and control returns to the previous process.

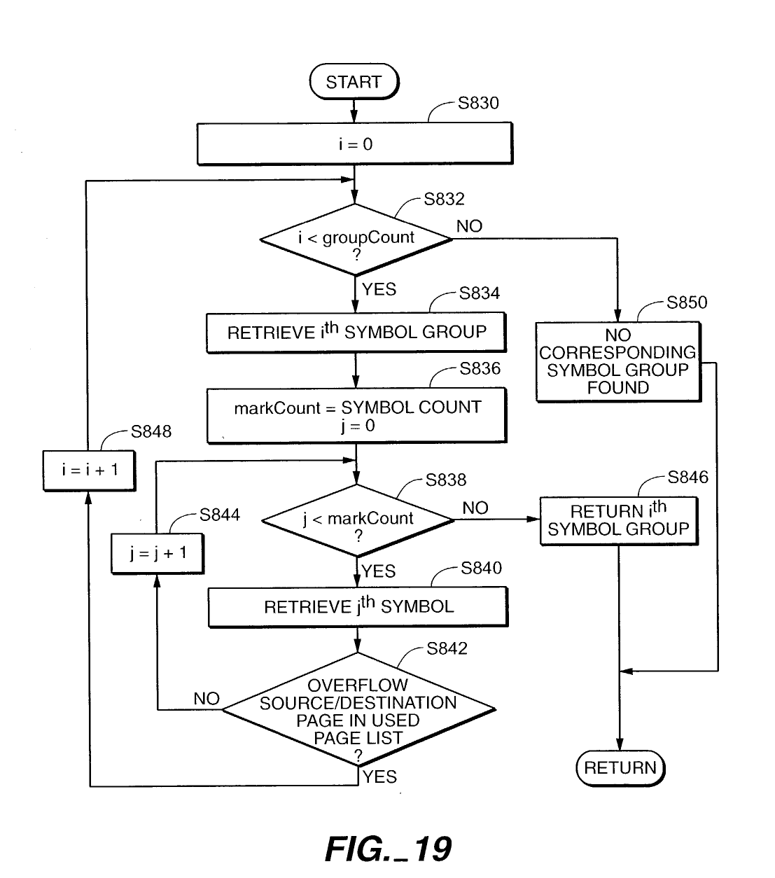

The symbol group search process run in step S716 is described in detail next with reference to the flow chart thereof shown in FIG. 19. When step S716 runs this symbol group search routine starts from step S830 as shown in FIG. 19.

The search routine starts by initializing counter variable i to 0 in step S830, and then comparing counter variable i with the variable groupCount in step S832. Variable groupCount stores the total number of symbol groups. If counter variable i is less than groupCount (step S832 returns yes), the symbol group with the group number indicated by counter variable i is retrieved in step S834 and control steps to step S836.

The total number of symbols in the retrieved symbol group is then set to variable markCount, and counter variable j is initialized to 0 in step S836. The value of counter variable j is then compared with markCount in step S838. If counter variable j is less than markCount (step S838 returns yes), the symbol with the symbol number indicated by counter variable j is retrieved in step S840.

Whether a source page or destination page number is recorded in the used page list for the retrieved symbol is then determined (step S842). If a source page or destination page number is not recorded in the used page list (step S842 returns no), counter variable j is incremented by 1 in step S844, and control loops back to step S838.

If in step S838 the counter variable j greater than or equal to markCount (step S838 returns no), control branches to step S846 and the symbol group identified by the group number indicated by counter variable i is returned to the calling procedure, the procedure then ends, and control returns to the previous process.

If in step S832 counter variable i is greater than or equal to groupCount (step S832 returns no), the calling procedure is notified in step S850 that there is no symbol group of which all member symbols are unused on the source page or the destination page, that is, all symbol groups have at least one member symbol used on the source page or destination page, the procedure then ends, and control returns to the previous process.

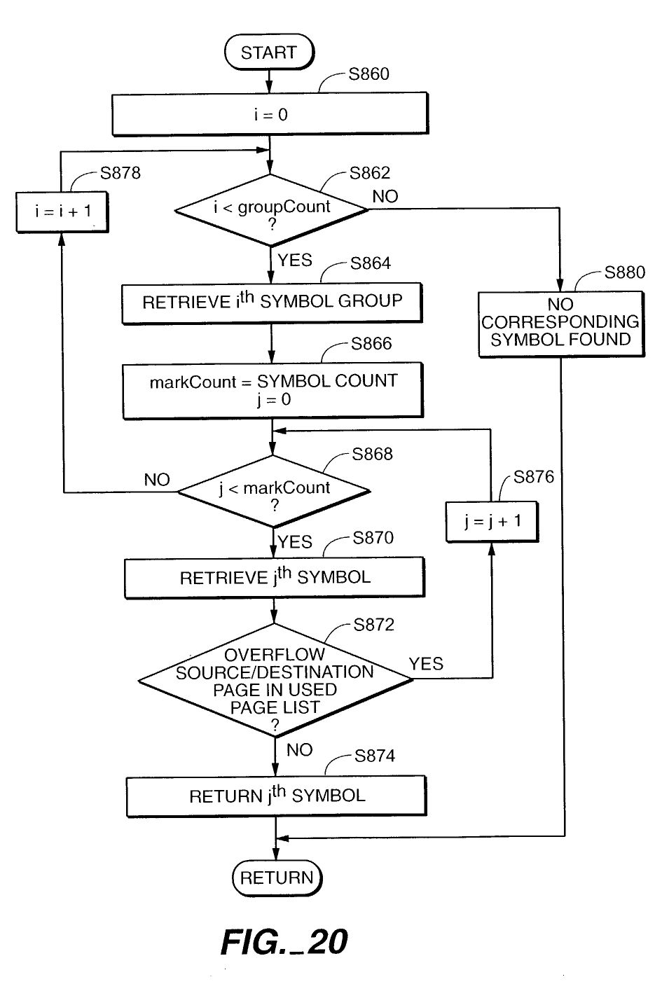

The symbol search routine run as step S720 above is described in detail next with reference to the flow chart thereof shown in FIG. 20. This search routine starts from step S860 as shown in FIG. 20 by initializing counter variable i to 0, and then comparing the counter variable i with the variable groupCount in step S862. If counter variable i is less than groupCount (step S862 returns yes), the symbol group with the group number indicated by counter variable i is retrieved in step S864.

The total number of symbols in the retrieved symbol group is then set to variable markCount, and counter variable j is initialized to 0 in step S866. The value of counter variable j is then compared with markCount in step S868. If counter variable j is less than markCount (step S868 returns yes), the symbol with the symbol number indicated by counter variable j is retrieved in step S870.

Whether a source page or destination page number is recorded in the used page list for the retrieved symbol is then determined (step S872). If a source page or destination page number is not recorded in the used page list for the retrieved symbol (step S872 returns no), the symbol with the symbol number indicated by counter variable j is returned to the calling process in step S874, the procedure then ends, and control returns to the previous process.

If a source page or destination page number is recorded in the used page list for the retrieved symbol (step S872 returns yes), the counter variable j is incremented 1 in step S876, and control loops back to step S868.

If in step S868 counter variable j is greater than or equal to markCount (step S868 returns no), counter variable i is incremented by 1 in step S878, and control loops back to step S862.

If in step S862 counter variable i is greater than or equal to groupCount (step S862 returns no), the calling procedure is informed that there are no symbols that are not used on the source page and destination page, the procedure then ends, and control returns to the previous process.

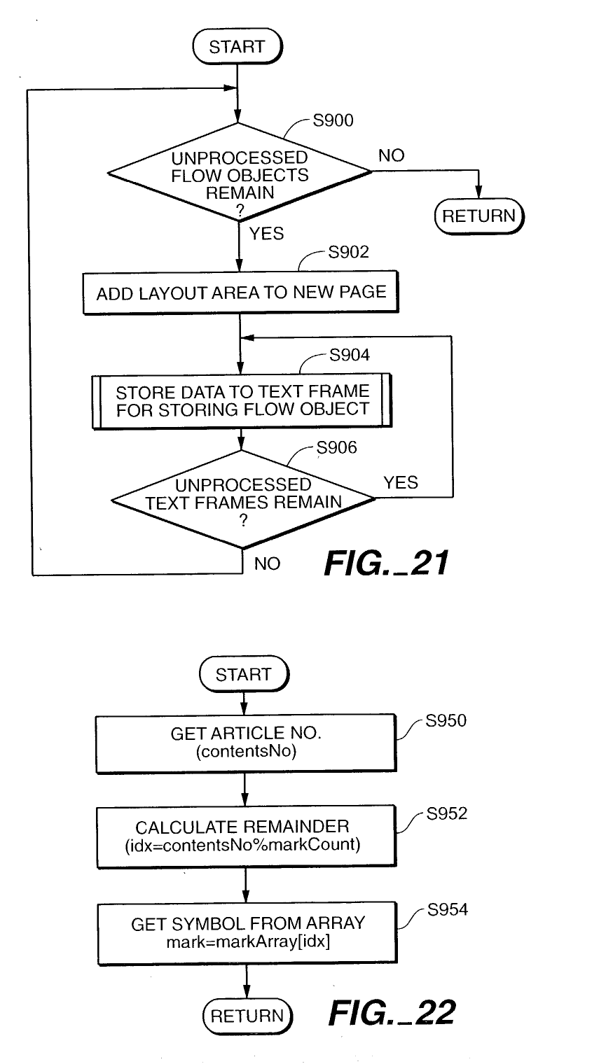

The routine for handling unprocessed flow objects in the above step S322 is described in detail next with reference to the flow chart thereof shown in FIG. 21. When the routine for handling unprocessed flow objects runs in step S322 it starts from step S900 as shown in FIG. 21.

The flow management table 400 is searched sequentially from the first record to find a record for which the process flag is cleared in step S900. If there is a record for which the process flag is not set (step S900 returns yes), control advances to step S902, but otherwise (if step S900 returns no) the procedure then ends and control returns to the previous process.

A layout area 360 is added to a new page in step S902. The same process run in step S308 for determining the shape and location of the text data frame for storing the flow object and flowing the flow object into the text frame is then run in step S904. Whether there are any unprocessed data storage frames in the layout area 360 is then determined (step S906). If there are (step S906 returns yes), control loops back to step S904. If there are no unprocessed data storage frames (step S906 returns no), control loops back to step S900.

The operation of a preferred embodiment of the present invention is described next. Recording the information needed for digital content distribution is described first.

If a user wants to receive digital content the user accesses the content distribution terminal 100 from user terminal 200 using a web browser and inputs a user registration request.

When a user registration request is input from the user terminal 200, the content distribution terminal 100 returns a request to the user for inputting the required user information. The user then returns the requested user information to the content distribution terminal 100. The required user information includes in this embodiment the main category, subcategory, user ID, password, distribution address, distribution date and time, layout number, maximum page count, and font size as described above.

When the content distribution terminal 100 receives the user information according to the request, it records the received user information to the user profile table 300 as described above in steps S100 to S114.

Distributing digital content by referencing the user profile table 300 is described next. When the content distribution terminal 100 determines by referencing the user profile table 300 that it is the date and time for digital content distribution, it reads the category number from the user profile table 300 (steps S204, S206), searches the content database 42 for digital content matching the read category number, and retrieves the digital content with a matching category number.

The layout number is then read from the user profile table 300 (steps S208 to S212), the layout number correspondence table 330 is referenced and the layout definition file corresponding to the read layout number is read from the user information database 40. The output layout for the retrieved digital content is then determined based on the layout definition file, and the digital content for distribution is produced.

The position of fixed lines, the shape and location of fixed text data, and the shape and location of fixed image data are then sequentially determined in the layout process (steps S300 to S310), and based on a predefined order of precedence the articles to be placed in the layout area 360 are selected from the digital content retrieved in step S206.

If title information is included in the selected article the title information from the article is written into the title frame (step S312). More specifically, the size of the title data in the selected article is determined, based thereon the shape and location of the title frame are determined, and the title data from the selected article is then stored to the resulting title frame.

If images are included in the selected article the image data from the selected article is stored to image data frames (step S314). More specifically, the size of the image included in the selected article is determined, based thereon the shape and location of the image frame are determined so as to not overlap any other data storage frame, and the image data from the selected article is then stored to the resulting image frame.

If text data is included in the selected article the text from the article is stored to a text data storage frame (step S316). More specifically, the amount of text included in the selected article is determined, based thereon the shape and location of the text frame are determined so as to not overlap any other data storage frame, and the text data from the selected article is then stored to the resulting text frame (steps S402 to S406).

If the text data will not all fit in the defined text frame and thus overflows, a record for the flow object is written to the end of the flow management table 400 (steps S408, S414, and S600 to S604). It should be noted that if the text fits into the text frame a record is not inserted to the flow management table 400 and operation ends.

These routines for storing data appropriately to the title frame, image data frames, and text frames repeat until there are no unprocessed data storage frames in the layout area 360. The selected article is thus placed in the layout area 360 of one page.

When there are no unprocessed data storage frames left in the layout area 360 the layout area 360 for the next page in the layout definition file read in step S210 is set as the process object (step S324). The routines for appropriately storing flow objects to the text data frames, storing data to the title frames, storing data to the image data frames, and storing data to the text frames are then run for the layout area 360 of this next page, and repeat until there are no unprocessed data storage frames in that layout area 360.

If there is a flow object, the flow object is written to a text frame in the flow object storage routine (step S308). More specifically, the flow object is read, the size of the read flow object determined, based thereon the shape and location of the text frame are determined so as to not overlap any other data storage frame, and text data from the selected article is stored to the resulting text frame (steps S504 to S510). The page number field of the corresponding flow object record is then set to the current page number and the process flag is set (steps S512, S514), and guidance information is added to the overflowing text frame and the overflow text frame.

Guidance information relating to the location of other data storage frames is added to the overflowing text frame and overflow text frame, and the same symbol is added to the guidance information so that the correlation between the overflowing text frame and overflow text frame is clear. Symbols are added as follows.

The first step is to find from among the plural symbol groups a symbol group of which none of the member symbols is used on any page (steps S700 to S704). When a corresponding symbol group is retrieved the first symbol in the symbol group is retrieved (steps S706, S708), and guidance information containing the retrieved symbol is added to the overflowing text frame and overflow text frame. For example, if the retrieved symbol is n, the source page is page 1, and the destination page is page 5, the character string “nn continued on page 5 nn” is appended to the overflowing text frame, and the character string “nn continued from page 1 nn” is appended to the overflow text frame.

If a symbol group for which all member symbols are unused on all pages cannot be found, the plural symbol groups are searched for a symbol that is not used on any page (steps S712, S714). If a corresponding symbol is found and retrieved, guidance information containing that symbol is added to the overflowing text frame and overflow text frame (step S708).

If a symbol not used on any page cannot be found, the plural symbol groups are searched for a symbol group of which all member symbols are unused on the source page and destination page (steps S716, S718). If a corresponding symbol group is found the first symbol in the symbol group is retrieved and guidance information containing the retrieved symbol is added to the overflowing text frame and overflow text frame (steps S706, S708).

If a symbol group having no member symbols used on the overflow source page and overflow destination page cannot be found, the plural symbol groups are searched for a symbol that is not used on the source page and destination page (steps S720, S722). If such a symbol is found, guidance information containing that symbol is added to the overflowing text frame and overflow text frame (step S708).

If the flow object cannot fit completely in the text frame and overflows again, a record for that flow object is inserted to the beginning of the flow management table 400 (steps S516, S520, S600, S602, S606). If the flow object fits completely into the text frame, the corresponding flow object is updated (steps S516) and operation ends.

Repeating these routines for storing flow objects to text frames, title data to title frames, images to image frames, and text data to text frames continues for all pages of the layout definition file read in step S210. Articles are thus placed in the layout area 360 of every page, and the output layout of the digital content is set. Once the output layout is set the distribution address is read from the user profile table 300 and the digital content generated for distribution is sent to the distribution address (steps S222, S224).

If there is an unprocessed flow object left after processing the layout area 360 for all pages in the layout definition file read in step S210, steps S902 to S906 repeat to add a new page layout area 360, place a text frame for storing the flow object in the new layout area 360, determine the shape and location of the text frame based on the size of the flow object, and store the flow object in the text frame until there are no unprocessed flow objects.

When text data will not fit in the text frame, the content distribution terminal 100 of the present embodiment stores any text data flow object that will not fit completely into a defined text frame to another text frame, and adds the same symbol to the overflowing text frame and overflow text frame.

The relationship between an overflowing text frame and the overflow text frame can thus be understood fairly easily by means of the appended symbols even when text data will not fit completely into a text frame and overflows, and the digital content prepared for distribution can be read more easily than with the prior art.

Furthermore, because symbols that are easy to recognize visually are added to the text frames, the correlation between the overflowing text frame and the overflow text frame can be readily perceived.

The content distribution terminal 100 of the present embodiment adds guidance information about the location of another text data frame to the overflowing text frame and overflow text frame, and includes an identifying symbol in the guidance information.

By thus including an identifying symbol in the guidance information added to the text frame, the correlation between the overflowing text frame and overflow text frame is even easier to determine.

Furthermore, the content distribution terminal 100 of the present embodiment looks in plural symbol groups for a symbol group of which all member symbols are unused on all of the layout pages, and selects a symbol from the retrieved symbol group.

This increases the likelihood that neither the same symbol nor similar symbols from the same symbol group will be used throughout the layout pages, i.e., that visually distinctive symbols will be used. The possibility of mistaking the correlation between text frames is therefore reduced, and the correlation between overflowing text frames and overflow text frames is even easier to recognize.

The content distribution terminal 100 in this embodiment also searches the plural symbol groups for symbols that are not used in any of the layout pages. This increases the likelihood that the same symbol is not used elsewhere throughout the layout pages. The possibility of mistaking the correlation between text frames is therefore reduced, and the correlation between overflowing text frames and overflow text frames is even easier to recognize.

The content distribution terminal 100 of the present embodiment also searches plural symbol groups for a symbol group of which all member symbols are unused on the overflow source page and the overflow destination page, and selects a symbol from the retrieved symbol group.

This increases the likelihood that neither the same symbol nor similar symbols from the same symbol group are used in the source page and destination page, i.e., that visually distinctive symbols will be used. The possibility of mistaking the correlation between text frames is therefore reduced, and the correlation between overflowing text frames and overflow text frames is even easier to recognize.

Yet further, the content distribution terminal 100 of this embodiment searches plural symbol groups for a symbol that is not used in the source page and destination page.

This increases the likelihood that the same symbol is not used more than once in the source page and destination page. The possibility of mistaking the correlation between text frames is therefore reduced, and the correlation between overflowing text frames and overflow text frames is even easier to recognize.

As also described above the content distribution terminal 100 of the present embodiment adds the symbol selected in steps S702 and S706 when such a symbol is found, adds the symbol selected in step S712 when a symbol cannot be selected in steps S702 and S706, adds the symbol selected in steps S716 and S706 when a symbol cannot be selected in step S712, and adds the symbol selected in step S720 when a symbol cannot be selected in steps S716 and S706.

When the number of text data storage frames containing flow objects increases, this configuration enables the selected symbol to be adjusted appropriately so that similar or identical symbols are not used.

Furthermore, when an unprocessed flow object remains after placing articles in all layout areas 360 defined by the layout definition file, the content distribution terminal 100 of the present embodiment adds a new layout area 360, places a text frame on the new layout area 360, and stores the unprocessed flow object in the text frame placed in the new layout area 360. It is therefore possible to prevent omitting digital content that should be included.

Yet further, the content distribution terminal 100 of the present embodiment repeats this operation of adding new layout areas 360, placing flow object frames, and storing the flow objects until there are no more unprocessed flow objects. It is therefore possible to prevent omitting digital content that should be included.

Yet further, when a text frame containing a flow object overlaps another data storage frame, the content distribution terminal 100 of the present embodiment sets the shape and location of the other data storage frame so that it does not overlap the text frame holding the flow object. This configuration gives precedence to placing flow objects over the placement of information stored to the other data storage frame.

Yet further preferably the content distribution terminal 100 of the present embodiment selects digital content from the content database 42 based on user information stored in a user information database 40. Because information specific to the user or information specified by the user is thus referenced to select the digital content for distribution, digital content more closely matching the content desired by the user can be produced.

Yet further preferably the content distribution terminal 100 of the present embodiment selects a digital content output layout and generates the digital content for distribution based on user information from the user information database 40. Because information unique to the user or information specified by the user is thus referenced to select the output layout, digital content for distribution can be produced using an output layout more closely matching the output layout preferred by the user.

Yet further preferably the content distribution terminal 100 of the present embodiment determines the shape of the title, image data, and text data storage frames so that they are the smallest size required to hold the corresponding title information, image data, and text data. It is therefore possible to efficiently store the title information, image data, and text data to the title, image data, and text data storage frames.

Yet further preferably the content distribution terminal 100 of the present embodiment determines the shape and location of the data storage frames in the following order: title frame, image data frames, text data frames. Because the layout is thus determined in the order that should be emphasized in the layout, digital content can be produced for distribution using an output layout that is easy to read.

Furthermore, when the text will not fit completely into a text frame, the content distribution terminal 100 of the present embodiment records the article number and overflow location of the flow object in a flow management table 400, and when storing the flow object to a text frame reads the article number and overflow location from the flow management table 400 to store the flow object in text frames based on the retrieved article number and overflow location. The flow objects can therefore be placed systematically, enabling digital content to be produced for distribution using an output layout that is even easier to read.

Yet further preferably the content distribution terminal 100 of the present embodiment records new records to the flow management table 400 from the end of the table and reads from the beginning of the flow management table 400. Because flow objects are thus placed systematically, digital content can be produced for distribution using an output layout that is even easier to read.

Yet further preferably the second and subsequent times a flow object is recorded in the flow management table 400 for the same text data the content distribution terminal 100 of the present embodiment records the flow object record to the beginning of the flow management table 400. This enables flow objects recorded two or more times for the same text data to be placed preferentially, thereby making it possible to a certain extent to avoid distributing the text over a large number of pages.

Furthermore, the content distribution terminal 100 of the present embodiment sets a process flag when the end of a flow object is stored to a text frame, and when storing a flow object to a text frame reads the article number and overflow location of a record for which the process flag is cleared from the flow management table 400. This makes processing flow objects using the flow management table 400 relatively simple.

It should be noted that in the preferred embodiment described above the digital content for distribution corresponds to the claim language digital content for output; the text data corresponds to the claim language included information; and the flow objects correspond to the claim language overflowing included information. In addition, the symbols correspond to the codes recited in certain claims, and to the identification information in other claims; the symbol groups correspond to the claim language code groups; and the text data storage frames correspond to the claim language data storage frames.

Furthermore, the user information database 40 corresponds to the claim language user information storage means; the content database 42 corresponds to the claim language content storage means; step S206 corresponds to the claim language content selection means and to the content selection step certain other claims; step S212 corresponds to the claim language content production means and to the content production step in certain other claims; and steps S702 and S706 correspond to the first code selection process in certain claims.

Yet further, step S712 corresponds to the second code selection process, steps S716 and S706 correspond to the third code selection process, and step S720 correspond to the fourth code selection process, as recited in various claims.

Furthermore, the content distribution terminal 100 in the above-described embodiment adds a symbol to overflowing text frames and overflow text frames by means of the process as shown in the flow charts in FIG. 16 to FIG. 20. The invention shall not be so limited, however, and can be configured to add a symbol using the symbol appending process shown in the flow chart in FIG. 22. This symbol appending process is described below with reference to the flow chart thereof in FIG. 22.

This symbol appending process records symbols such as recorded in the above symbol registration table 420 in the array variable markArray[ ], and retrieves symbols from this markArray[ ] variable. When the CPU 30 runs this symbol appending process it starts from step S950 as shown in FIG. 22.

The article number of the flow object is retrieved and stored to the article number variable contentsNo in step S950. The variable contentsNo is then divided by variable markCount to obtain the remainder, and the remainder is stored to variable idx (step S952).

The idxth symbol from the beginning of markArray[ ] is then stored to variable mark in step S954, the procedure then ends, and control returns to the previous process. Though not shown in this flow chart, the symbol stored to the variable mark is also appended to the overflowing text frame and overflow text frame.

Furthermore, while the content distribution terminal 100 of the present embodiment is configured to add the selected symbol to the overflowing text frame and overflow text frame, it can instead be configured to add color. The color in this case can be selected according to the same operation described above.

In this case the digital content for distribution corresponds to the claim language digital content for output; the text data corresponds to the claim language the included information; and the flow objects correspond to the claim language the overflowing included information. In addition, the text data storage frames correspond to the claim language the data storage frames; the user information database 40 corresponds to the claim language the user information storage means; and the content database 42 corresponds to the claim language content storage means.

Furthermore, step S206 corresponds to content selection means in certain claims and to the content selection step in other claims; step S212 corresponds to the content production means in certain claims and to the content production step in other claims.

In addition, steps S702 and S706 correspond to the first color selection process in certain claims; step S712 corresponds to the second color selection process in certain claims; steps S716 and S706 correspond to the third color selection process in certain claims; and step S720 corresponds to the fourth color selection process in certain claims.

The content distribution terminal 100 of the present embodiment is also designed to select symbols according to specific rules regardless of the content of the text data stored to the overflowing text frame and overflow text frame. The invention shall not be so limited, however, and the symbols can be selected based on the content of the text data stored to the overflowing text frame and overflow text frame. For example, if the content of the text data relates to baseball an icon with a baseball or baseball bat could be used, and if the content relates to the economics an icon with a currency or money design could be used. The text data content can be determined by referencing the category numbers recorded in the category number correspondence table 340.

In this case the text data corresponds to the included information in certain claims, and step S212 corresponds to the content production means in certain claims and to the content production step in other claims.

Furthermore, when the text frame storing a flow object and another data storage frame overlap, the content distribution terminal 100 of the present embodiment sets the shape and location of the other data storage frame so that it does not overlap the text frame storing the flow object. The invention shall not be so limited, however, and the shape and location of the text frame storing the flow object can be set when the flow object text frame and another data storage frame will overlap so that there is no overlap with the other data storage frame. This can be accomplished by running the same process run in step S404 in step S508.

In this case the placement of information stored to another data storage frame can be given precedence over the placement of flow objects.

The content distribution terminal 100 of the present embodiment adds guidance information to the overflowing text frame and overflow text frame as described above, but could also include link information denoting the other linked text frame with the guidance information.

In this case a user receiving digital content can click on the guidance information with a mouse to jump to and reference the location equivalent to where the corresponding overflowing text frame or overflow text frame is located based on the contained link.

The content distribution terminal 100 of the present embodiment adds guidance information to the overflowing text frame and overflow text frame as described above, but could alternatively add the guidance information only to the overflowing text frame or the overflow text frame. In this case only the symbol is added to the end of the text frame to which the guidance information is not added.

The content distribution terminal 100 further preferably handles text data as flow objects as described above but shall not be so limited and could also handle title data and image data as flow objects. It is, however, not desirable for title data or image data to overflow the respective title or image data frame, and not applying a data flowing process such as applied with the text data is actually preferable with respect to the layout.

The shape and location of the data storage frames are also determined in order from the title frame, image data frames, and finally the text frames, but the invention shall obviously not be so limited and the shape and location of the data storage frames can be determined in any desired order. The order in which the shape and location are determined can also be recorded in the user profile table 300 as user preference information.

The shape and location of the data storage frames are also determined dynamically in this preferred embodiment, but the invention shall obviously not be so limited and the layout can be determined by setting the shape and location of each data storage frame after first storing data to all data storage frames in the layout area 360.

The digital content output layout is also preferably determined based on user information in the present embodiment. The invention shall not be so limited, however, and the digital content output layout can be determined based on the number of images in the digital content or the amount of text contained in the digital content.

This makes it possible to produce a relatively easy-to-read output layout whether the number of images or the amount of text included in the digital content is large or small.

Furthermore, the layout process of step S212 is run by the content distribution terminal 100 in the present embodiment. The invention shall not be so limited, however, and the layout process can be run on the user terminal 200. This reduces concentrating the processing load on the content distribution terminal 100.

A control program pre-stored in ROM 32 is executed to run the processes shown in the flow charts in FIG. 11 to FIG. 21 in the present embodiment, but the invention shall not be so limited. A program containing these procedures could be read from an appropriate storage medium into RAM 34 and run from RAM 34.

The storage medium for storing this program could be a semiconductor memory device such as RAM or ROM, a magnetic storage device such as a floppy disk or hard disk, an optically readable storage medium such as a CD, CDV, LD, or DVD, or a magnetically writable, optically readable storage medium such as a magneto-optical (MO) disk. More specifically, the storage medium can be any computer-readable storage medium, whether it is read electronically, magnetically, optically, or otherwise.

The digital content production system, digital content production program, and digital content production method of the present invention are described herein as applied to a network system such as the Internet 199, but shall not be so limited. The invention can also be implemented over an intranet enabling communication similarly to the Internet 199.

Furthermore, the digital content production system, digital content production program, and digital content production method of the present invention is described with reference to a content distribution terminal 100 distributing digital content such as news to a user terminal 200 as shown in FIG. 1, but shall not be so limited and can be used for various other applications without departing from the scope of the accompanying claims.

As will be clear from the preceding description of the invention, a digital content production system enables the correlation between data storage frames to be grasped relatively easily by means of appended identification information even when the included information is segmented and stored to different data storage frames. The digital content production system of the invention therefore produces digital content for output that is easier to read when compared with the prior art.

Furthermore, when the included information will not fit completely in a data storage frame and overflows, the digital content production system enables the correlation between the overflowing text frame and overflow text frame to be grasped relatively easily by means of appended identification information. The digital content production system of the invention therefore produces digital content for output that is easier to read when compared with the prior art.

Furthermore, because identification information is included in guidance information added to the data storage frames, the digital content production system of this invention makes it even easier to grasp the correlation between the overflowing text frame and overflow text frame.

Furthermore, because the digital content production system of this invention adds a visually distinctive code to the data storage frame, the correlation between overflowing text frame and overflow text frame can be grasped intuitively.

Furthermore, because the digital content production system of this invention appends the same code to corresponding overflowing text frames and overflow text frames, the correlation between overflowing text frame and overflow text frame can be grasped even more easily.

Furthermore, because the digital content production system of this invention appends a different code to data storage frames of different content, code recognition is improved and the correlation between overflowing text frame and overflow text frame is even easier to understand.

Furthermore, because the likelihood is increased that the same code is not used throughout a wide range of pages with the digital content production system of this invention, the likelihood of mistaking the correlation between data storage frames is reduced and the correlation between overflowing text frame and overflow text frame can be understood even more easily.

Furthermore, because the types of codes used to denote the correlation between data storage frames are reduced with the digital content production system of this invention, code recognition is improved and the correlation between overflowing text frame and overflow text frame is even easier to understand.

Furthermore, because the likelihood that same or similar codes from the same code group are not used across all pages is increased with the digital content production system of this invention, the likelihood of mistaking the correlation between data storage frames is reduced and the correlation between overflowing text frame and overflow text frame can be understood even more easily.

Furthermore, because the likelihood that the same code is not used again across all pages is increased with the digital content production system of this invention, the likelihood of mistaking the correlation between data storage frames is reduced and the correlation between overflowing text frame and overflow text frame can be understood even more easily.

Furthermore, because the likelihood is increased that similar or same codes from the same code group are not used on the pages on which the overflowing text frame and overflow text frame are located with the digital content production system of this invention, the likelihood of mistaking the correlation between data storage frames is reduced and the correlation between overflowing text frame and overflow text frame can be understood even more easily.

Furthermore, because the likelihood is increased that the same code is not used again on the pages on which the overflowing text frame and overflow text frame are located with the digital content production system of this invention, the likelihood of mistaking the correlation between data storage frames is reduced and the correlation between overflowing text frame and overflow text frame can be understood even more easily.

Furthermore, when the number of data storage frames for storing included information overflow increases, the digital content production system of this invention can make relatively appropriate adjustments so that similar or identical codes are not used.

Furthermore, because a code determined by the content of the included information is appended to a data storage frame with the digital content production system of this invention, the correlation between overflowing text frame and overflow text frame can be understood in terms of content.

Furthermore, because visually distinctive colors are added to the data storage frames with the digital content production system of this invention, the correlation between overflowing text frame and overflow text frame can be intuitively understood.

Furthermore, because the digital content production system of this invention adds the same color to corresponding overflowing text frames and overflow text frames, the correlation between overflowing text frame and overflow text frame can be understood even more easily.

Furthermore, because the digital content production system of this invention adds different colors to data storage frames containing different, unrelated content, color recognition improves and the correlation between overflowing text frame and overflow text frame can be understood even more easily.

Furthermore, because the likelihood is increased that the same color is not used throughout -a wide range of pages with the digital content production system of this invention, the likelihood of mistaking the correlation between data storage frames is reduced and the correlation between overflowing text frame and overflow text frame can be understood even more easily.

Furthermore, because the types of colors used to denote the correlation between data storage frames are reduced with the digital content production system of this invention, color recognition is improved and the correlation between overflowing text frame and overflow text frame is even easier to understand.

Furthermore, because the likelihood that same or similar colors from the same color group are not used across all pages is increased with the digital content production system of this invention, the likelihood of mistaking the correlation between data storage frames is reduced and the correlation between overflowing text frame and overflow text frame can be understood even more easily.

Furthermore, because the likelihood that the same color is not used across all pages is increased with the digital content production system of this invention, the likelihood of mistaking the correlation between data storage frames is reduced and the correlation between overflowing text frame and overflow text frame can be understood even more easily.

Furthermore, because the likelihood is increased that similar or same colors from the same color group are not used on the pages on which the overflowing text frame and overflow text frame are located with the digital content production system of this invention, the likelihood of mistaking the correlation between data storage frames is reduced and the correlation between overflowing text frame and overflow text frame can be understood even more easily.

Furthermore, because the likelihood is increased that the same color is not used on the pages on which the overflowing text frame and overflow text frame are located with the digital content production system of this invention, the likelihood of mistaking the correlation between data storage frames is reduced and the correlation between overflowing text frame and overflow text frame can be understood even more easily.

Furthermore, when the number of data storage frames for storing included information overflow increases, the digital content production system of this invention can make relatively appropriate adjustments so that similar or identical colors are not used.

Furthermore, because a color determined by the content of the included information is appended to a data storage frame with the digital content production system of this invention, the correlation between overflowing text frame and overflow text frame can be understood in terms of content.

Furthermore, the digital content production system of this invention references user-specific information or information specified by the user when selecting digital content for distribution, and can therefore produce digital content for output with content relevant to the information sought by the user.

Furthermore, the digital content production system of this invention references user-specific information or information specified by the user when determining the output layout, and can therefore produce digital content for output using an output layout conforming to the output layout preferred by the user.

Although the present invention has been described in connection with the preferred embodiments thereof with reference to the accompanying drawings, various changes and modifications will be apparent to those skilled in the art. The invention is intended to embrace all such changes and modifications that fall within the scope of the appended claims.

What is claimed is:

1. A digital content production system, comprising:
content production means for determining an output layout for selected digital content and producing the selected digital content for output, the content production means segmenting and storing included information of the selected digital content in different ones of a plurality of data storage frames placed in a layout area to produce the digital content for output, wherein the content production means appends related identification information to each data storage frame in which the included information is stored.

2. A digital content production system, comprising:
content storage means for storing digital content;
content selection means for selecting digital content from the content storage means; and
content production means for determining an output layout for the selected digital content and producing digital content for output, the content production means segmenting and storing included information of the selected digital content in different ones of a plurality of data storage frames placed in a layout area to produce digital content for output, wherein, when the included information cannot be completely stored in a particular data storage frame, the content production means stores overflow information of the included information that could not be stored in the particular data storage frame (overflowing data storage frame) to an overflow data storage frame and appends identification information to the overflowing data storage frame and to the overflow data storage frame identifying the overflowing and overflow data storage frames as related.

3. A digital content production system as described in claim 2, wherein the identification information includes guidance information relating to the location of the overflow data storage frame, or to the location of the overflowing data storage frame.

4. A digital content production system as described in claim 2, wherein the identification information is a code.

5. A digital content production system as described in claim 4, wherein the content production means appends the same code to the overflowing data storage frame and to the overflow data storage frame.

6. A digital content production system as described in claim 5, wherein the content production means appends different codes to data storage frames containing unrelated content.

7. A digital content production system as described in claim 6, wherein the content production means selects a code from a specific code group so as to increase the likelihood that the same code is not used for more than one group of related data storage frames within a specific range.

8. A digital content production system as described in claim 6, wherein the content production means selects a code from a specific code group so that fewer code types are used throughout the entire layout area.

9. A digital content production system as described in claim 7, wherein there are plural code groups, each code group containing a plurality of similar codes that are different from the codes in other code groups, and wherein the content production means produces digital content for output containing plural page unit layout areas, selects a code from the plural code groups according to code usage on each page, and appends the selected code to the overflowing data storage frame and to the overflow data storage frame.

10. A digital content production system as described in claim 9, wherein the content production means runs a first code selection process for searching the plural code groups for a code group of which none of the member codes has been used on any page, and selecting a code from the code group retrieved by the search.

11. A digital content production system as described in claim 10, wherein the content production means runs a second code selection process for selecting from the plural code groups a code that has not been used on any page.

12. A digital content production system as described in claim 11, wherein the content production means runs a third code selection process for searching the plural code groups for a code group of which none of the member codes has been used on any page on which is placed the overflowing data storage frame or the overflow data storage frame, and selecting a code from the code group found by the third code selection process.

13. A digital content production system as described in claim 12, wherein the content production means runs a fourth code selection process for selecting from the plural code groups a code that has not been used on any page on which is placed the overflowing data storage frame or the overflow data storage frame.

14. A digital content production system as described in claim 13, wherein the content production means appends the code selected by the first code selection process when such code is available, appends the code selected by the second code selection process when a code cannot be selected by the first code selection process, appends the code selected by the third code selection process when a code cannot be selected by the second code selection process, or appends the code selected by the fourth code selection process when a code cannot be selected by the third code selection process.

15. A digital content production system as described in claim 5, wherein the content production means selects a code based on the content of the included information, and appends the selected code to the overflowing data storage frame and to the overflow data storage frame.

16. A digital content production system as described in claim 2, wherein the identification information is color.

17. A digital content production system as described in claim 16, wherein the content production means adds the same color to the overflowing data storage frame and to the overflow data storage frame.

18. A digital content production system as described in claim 17, wherein the content production means adds different colors to data storage frames containing unrelated content.

19. A digital content production system as described in claim 18, wherein the content production means selects colors from a specific color group so as to increase the likelihood that the same color is not used for more than one group of related data storage frames within a specific range.

20. A digital content production system as described in claim 18, wherein the content production means selects a color from a specific color group so that fewer color types are used throughout the entire layout area.

21. A digital content production system as described in claim 20, wherein there are plural color groups, each color group containing a plurality of similar colors that are different from the colors in other color groups, wherein the content production means produces digital content for output containing plural page unit layout areas, selects colors from the plural color groups according to color usage on each page, and adds the selected colors to the overflowing data storage frame and to the overflow data storage frame.

22. A digital content production system as described in claim 19, wherein the content production means runs a first color selection process for searching the plural color groups for a color group of which none of the member colors has been used on any page, and selecting a color from the color group retrieved by the search.

23. A digital content production system as described in claim 22, wherein the content production means runs a second color selection process for selecting from the plural color groups a color that has not been used on any page.

24. A digital content production system as described in claim 23, wherein the content production means runs a third color selection process for searching the plural color groups for a color group of which none of the member colors has been used on any page on which is placed the overflowing data storage frame or the overflow data storage frame, and selecting a color from the color group found by searching.

25. A digital content production system as described in claim 24, wherein the content production means runs a fourth color selection process for selecting from the plural color groups a color that has not been used on any page on which is placed the overflowing data storage frame or the overflow data storage frame.

26. A digital content production system as described in claim 25, wherein the content production means appends the color selected by the first color selection process when such color is available, appends the color selected by the second color selection process when a color cannot be selected by the first color selection process, appends the color selected by the third color selection process when a color cannot be selected by the second color selection process, or appends the color selected by the fourth color selection process when a color cannot be selected by the third color selection process.

27. A digital content production system as described in claim 17, wherein the content production means selects a color based on the content of the included information, and adds the selected color to the overflowing data storage frame and to the overflow data storage frame.

28. A digital content production system as described in claim 2, further comprising a user information storage means for storing user information relating to a user, the content selection means selecting digital content from the content storage means based on user information from the user information storage means.

29. A digital content production system as described in claim 2, further comprising a user information storage means for storing user information relating to a user, the content production means determining the output layout for digital content selected by the content selection means based on user information from the user information storage means.

30. A device-readable medium containing a digital content production program for running a digital content production process on a device capable of reading the medium, the program comprising:
instructions for determining an output layout for selected digital content and producing the selected digital content for output;
instructions for segmenting and storing included information of the selected digital content in different ones of a plurality of data storage frames placed in a layout area to produce the digital content for output; and
instructions for appending related identification information to each data storage frame in which the included information is stored.

31. A device-readable medium containing a digital content production program for running a digital content production process on a device capable of reading the medium, the program comprising:
instructions for selecting digital content from storage;
instructions for determining an output layout for the selected digital content and producing the selected digital content for output;
instructions for segmenting and storing included information of the selected digital content in different ones of a plurality of data storage frames placed in a layout area to produce digital content for output;
instructions for storing overflow information of the included information that could not be stored in the particular data storage frame (overflowing data storage frame) to an overflow data storage frame, when the included information cannot be completely stored in a particular data storage frame; and
instructions for appending identification information to the overflowing data storage frame and to the overflow data storage frame identifying the overflowing and overflow data storage frames as related.

32. A digital content production method, comprising:
determining an output layout for selected digital content and producing the selected digital content for output;
segmenting and storing included information of the selected digital content in different ones of a plurality of data storage frames placed in a layout area to produce the digital content for output; and
appending related identification information to each data storage frame in which the included information is stored.

33. A digital content production method, comprising:
selecting digital content from storage;
determining an output layout for the selected digital content and producing the selected digital content for output;
segmenting and storing included information of the selected digital content in different ones of a plurality of data storage frames placed in a layout area to produce digital content for output;
storing overflow information of the included information that could not be stored in the particular data storage frame (overflowing data storage frame) to an overflow data storage frame, when the included information cannot be completely stored in a particular data storage frame; and
appending identification information to the overflowing data storage frame and to the overflow data storage frame identifying the overflowing and overflow data storage frames as related.
